(19) United States
(12) Patent Application Publication
(10) Pub. No.: US 2010/0125554 A1
(43) Pub. Date: May 20, 2010

(54) Memory Recovery Across Reboots of an Emulated Operating System

(75) Inventors: Andrew T. Jennings, East Sussex (GB); Feng-Jung Kao, Minneapolis, MN (US); Michael J. Rieschl, St. Paul, MN (US); David W. Schroth, Minneapolis, MN (US)

Correspondence Address: UNISYS CORPORATION, UNISYS WAY, MAIL STATION: E8-114, BLUE BELL, PA, 19424, US

(73) Assignee: Unisys Corporation

(21) Appl. No.: 12/272,842

(22) Filed: Nov. 18, 2008

(51) Int. Cl. G06F 12/16; G06F 9/455; G06F 12/00; G06F 15/177; G06F 17/30; G06F 7/00

(52) U.S. Cl. 707/674; 703/23; 713/2; 711/162; 707/E17.01; 707/E17.044; 711/E12.001; 711/E12.103

(57) ABSTRACT

Approaches for recovering state data between boot sessions of an emulated operating system (OS). An OS is emulated on a host OS. In response to each memory acquire request from the emulated OS, an interface to the host OS returns a memory area for use by the emulated OS and stores allocation data associated with the memory area. The allocation data includes an address referencing the memory area and a boot sequence number that indicates a boot session of the emulated OS. While booting the second emulated OS to a current boot session, the stored allocation data is retrieved from the interface, and in response to the stored allocation data including a selected boot sequence number, data from the memory area referenced by the address in the allocation data is stored in retentive storage by the second OS.

### FIELD OF THE INVENTION

The current invention relates to a mechanism for providing enhanced analysis of the execution environment of a data processing system across reboots of an emulated operating system.

### BACKGROUND

In the past, software applications that require a large degree of data security and recoverability were traditionally supported by mainframe data processing systems. Such software applications may include those associated with utility, transportation, finance, government, and military installations and infrastructures. Such applications were generally supported by mainframe systems because mainframes provide a large degree of data redundancy, enhanced data recoverability features, and sophisticated data security features.

As smaller “off-the-shelf” commodity data processing systems such as personal computers (PCs) increase in processing power, there has been some movement towards using such systems to support industries that historically employed mainframes for their data processing needs. For instance, one or more personal computers may be interconnected to provide access to “legacy” data that was previously stored and maintained using a mainframe system. Going forward, the personal computers may be used to update this legacy data, which may comprise records from any of the aforementioned sensitive types of applications. This scenario presents several challenges, as follows.

First, as previously alluded to, the Operating Systems (OSes) that are generally available on commodity-type systems do not include the security and protection mechanisms needed to ensure that legacy data is adequately protected. For instance, when a commodity-type OS such as Windows or Linux experiences a critical fault, the system must generally be entirely rebooted. This involves reinitializing the memory and re-loading software constructs. As a result, in many cases, the operating environment, as well as much or all of the data that was resident in memory, at the time of the fault are lost. Therefore, data that may be useful for tracing the source of a problem may be unavailable for subsequent analysis.

For these and other reasons it has become popular to emulate a legacy OS (e.g., OS2200 from UNISYS® Corp.) on a machine operating under the primary control of a commodity OS (e.g., LINUX®). Part of developing such a system entails identifying source causes when the legacy OS stops unexpectedly or the developer is unexpectedly forced to manually stop the legacy OS. In order to effectively diagnose and fix problems, some or all of the execution state of the legacy OS must be available for analysis across reboots or “boot sessions” of the legacy OS. A boot session is the period beginning with the initial loading of legacy OS software and ending when the legacy OS ceases its system management functions, and a reloading of the legacy OS software is required for the legacy OS to return to performing its management functions.

Thus, what is needed is a system and method to address at least some of the aforementioned limitations.

A method and system that address these and other related issues are therefore desirable.

### SUMMARY

The various embodiments of the invention provide methods and systems for recovering state data between boot sessions of an operating system. In one embodiment, a first operating system (OS) is executed on an instruction processor of a data processing system. The first OS includes instructions of a first instruction set that are native to the instruction processor. A second OS is emulated using an interface to the first OS on the data processing system. The second OS and application programs include instructions of a second instruction set that are not native to the instruction processor. In response to each memory acquire request from the second OS to the interface, the interface returns a memory area for use by the second OS and stores allocation data associated with the memory area. The allocation data includes an address referencing the memory area and a boot sequence number. The boot sequence number indicates a boot session of the second OS. While booting the second OS to a current boot session, the stored allocation data is retrieved from the interface for the second OS. In response to the stored allocation data including a selected boot sequence number, data from the memory area referenced by the address in the allocation data is stored in one or more files in retentive storage by the second OS.

In another embodiment, a system is provided for recovering state data between boot sessions of an operating system. The system comprises a data processing system, an instruction processor (IP) emulator, and an interface. The data processing system includes a first type instruction processor and executes a first operating system (OS) that includes instructions of a first instruction set that are native to the first type instruction processor. The instruction processor (IP) emulator executes on the first OS and emulates execution of instructions of a second instruction set that are not native to the first type instruction processor. The IP emulator executes a second OS that includes instructions of the second instruction set. The interface is coupled to the IP emulator and executes on the first OS. The interface, responsive to each memory acquire request from the second OS to the interface, returns a memory area for use by the second OS and stores allocation data associated with the memory area. The allocation data includes an address referencing the memory area and a boot sequence number, and the boot sequence number indicates a boot session of the second OS. The second OS, while booting to a current boot session, retrieves the stored allocation data from the interface. Responsive to the stored allocation data including a selected boot sequence number, the second OS stores data from the memory area referenced by the address in the allocation data in one or more files in retentive storage.

In another embodiment, an apparatus is provided for recovering state data between boot sessions of an operating system. The apparatus comprises means for executing a first operating system (OS). The first OS includes instructions of a first instruction set that are native to an instruction processor. Means are provided for emulating a second OS. The second OS includes instructions of a second instruction set that are not native to the instruction processor. Means are provided for interfacing the second OS to the first OS during emulation. The means for interfacing, responsive to each memory acquire request from the second OS, returns a memory area for use by the second OS and stores allocation data associated with the memory area. The allocation data includes an address referencing the memory area and a boot sequence number. The boot sequence number indicates a boot session of the second OS. While booting the second OS to a current boot session during emulation, the second OS retrieves the stored allocation data from the interface. Responsive to the stored allocation data including a selected boot sequence number, the second OS stores data from the memory area referenced by the address in the allocation data in retentive storage.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a block diagram of an exemplary commodity-type data processing system that may be adapted for use with the current invention.

FIG. 2 is a block diagram of an example system in which embodiments of the current invention may be used.

FIG. 3 is a block diagram of constructs established by a legacy operating system during a boot session.

FIG. 4 is a timeline illustrating events that occur during a boot session of a legacy operating system according to one approach for handling recovery.

FIG. 5 is a timeline that represents multiple successive boot attempts for legacy OS according to the current invention according to one approach for handling recovery.

FIGS. 6A, 6B, and 6C are a flow diagram of one approach for booting an operating system.

FIG. 6D is a flow diagram of one approach for handling an error that occurs during the boot process of FIGS. 6A-6C.

FIG. 6E is a flow diagram of a method for booting an operating system in accordance with an embodiment of the invention;

FIG. 6F illustrates an allocation list that is used in managing memory allocations according to an embodiment of the invention;

FIGS. 7A and 7B, when arranged as shown in FIG. 7, are a flow diagram of a process performed by an operating system according to one approach for managing boot session data.

FIG. 7C is a flow diagram that illustrates processing performed to recover the memory associated with a Recovery Bank Area (RBA) according to one approach for recovering data in memory.

FIG. 7D is a flow diagram that illustrates processing performed to recover the data of a previous boot session according an embodiment of the invention;

FIG. 8 is a block diagram of an analysis system used to analyze state save files.

FIG. 9 is a block diagram of the paging logic according to one embodiment of the invention.

FIG. 10 is a flow diagram of a state save analysis process according to the current invention.

FIGS. 11A and 11B, when arranged as shown in FIG. 11, are a flow diagram illustrating a method of managing state save data as it is retrieved from the state save files and stored in simulation memory.

### DETAILED DESCRIPTION

### I. Data Processing System Environment

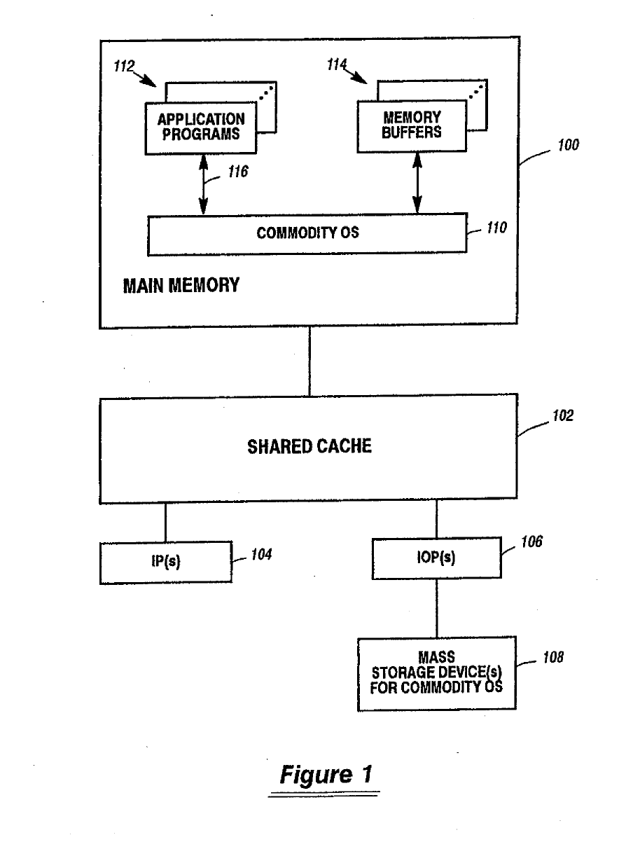

FIG. 1 is a block diagram of an exemplary commodity-type data processing system such as a personal computer, workstation, or other “off-the-shelf” hardware (hereinafter “commodity platform”) that may be adapted for use with the current invention. This system includes a main memory 100, which may optionally be coupled to a shared cache 102 or some other type of bridge circuit. The shared cache is, in turn, coupled to one or more instruction processors (IPs) 104. In one embodiment, the instruction processors include commodity-type IPs such as are available from Intel Corporation, Advanced Micro Devices Incorporated, or some other vendor that provides IPs for use in commodity platforms.

1n the exemplary system of FIG. 1, Input/Output processors (IOPs) 106 are coupled to shared cache. The IOPs provide access to mass storage devices 108, which may be disk drives and other devices suitable for storing retentive data.

A commodity operating system (OS) 110 such as UNIX®, LINUX®, WINDOWS®, or any other operating system adapted to operate on a commodity platform resides within main memory 100 of the illustrated system. The commodity OS is responsible for the management and coordination of activities and the sharing of the resources of the data processing system.

Commodity OS 110 acts as a host for Application Programs (APs) 112 that run on data processing system. For instance, if an AP requires use of one or more memory buffer 114 to perform one or more tasks, the AP makes a call to the commodity OS 110 for memory allocation. This call may be made via a standard Application Programming Interface (API) 116 that is provided for this purpose. The OS allocates a buffer of the requisite size and returns the address to this buffer in virtual address space. When the AP no longer requires use of the buffer, the AP makes a call to the OS to release that memory space so that it may be used for other purposes.

One limitation associated with use of commodity OS 110 involves data security. In some applications involving transportation, utility, government, banking, military, and other large-scale data processors, it is very important that data stored within mass storage device(s) 108 and in memory 100 be maintained in a secure state. The type of data protection and security mechanisms needed to accomplish this are not generally provided by commodity OSes. As an example, a commodity OS such as Linux utilizes an in-memory cache (not shown) to boost performance. This type of software cache that resides in main memory 100 may store data that has been retrieved from mass storage devices 108. Based on the types of requests made by APs 112, some updates to the cached data may be retained within main memory 100 and not written back to mass storage devices 108 for a long period of time. Other updates may be stored directly to the mass storage devices 108. This may lead to a “data coherency” problem wherein an older update that had been retained within memory for a long period of time eventually overwrites newer data that was stored directly to the mass storage devices. A commodity OS will generally not guard against this undesired result. Instead, the application programmer must ensure that this type of operation does not occur. This becomes increasingly difficult in a multi-processing environment wherein many different applications are making memory requests concurrently.

In addition to the foregoing limitation, commodity OSes such as UNIX and Linux allow operators a large degree of freedom and flexibility to control and manage the system. For instance, a user within a UNIX environment may enter a command from a shell prompt that could delete a large amount of data stored on mass storage devices without the system either intervening or providing a warning message. Such actions may be unintentionally initiated by novice users who are not familiar with the often cryptic command shell and other user interfaces associated with these commodity OSes.

Other limitations associated with commodity OSes involve recoverability following a system failure. Often times, when a critical error occurs within a commodity data processing platform, a “hard reboot” must be performed. This involves completely reinitializing the hardware as though power had just been applied to the hardware. When this occurs, main memory 100, IPs 104, and IOPs 106 are reinitialized. The state in which the machine was operating at the time the fault occurred is lost. Data resident in memory at the time of the fault is also generally lost. Therefore, execution cannot be resumed at the point at which the failure occurred. This is not acceptable when running applications that require a long mean time between failures and system stops. This is also not acceptable if critical data is being manipulated by the data processing system.

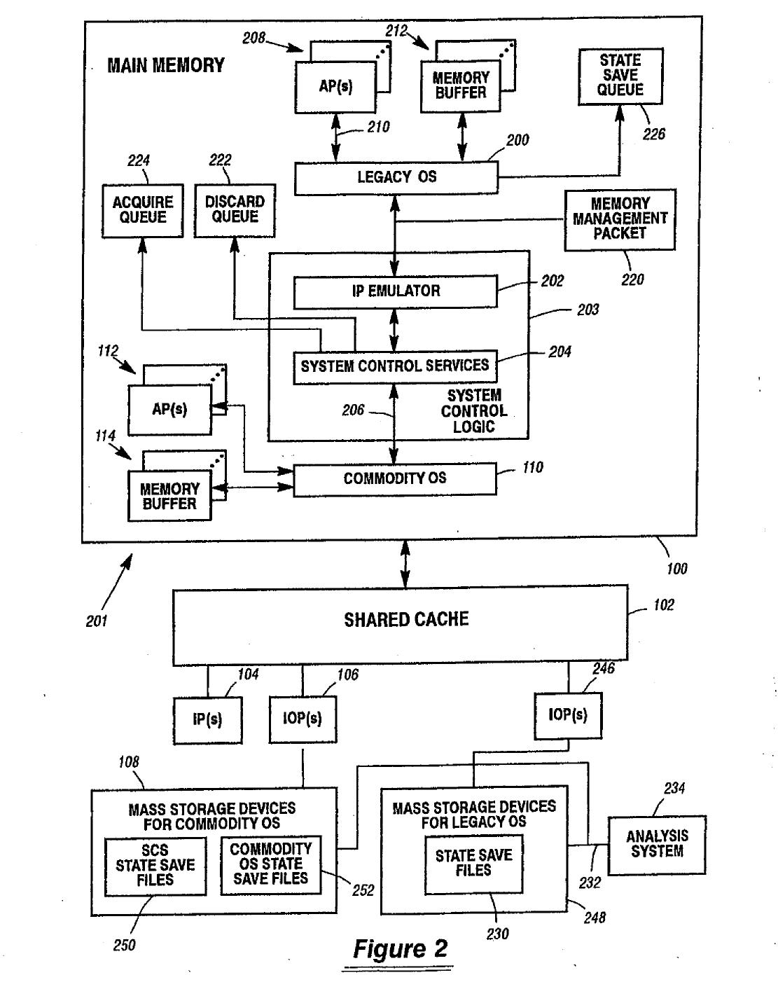

FIG. 2 is a block diagram of one exemplary embodiment of a data processing system that adapts the platform of FIG. 1 according to the current invention. In FIG. 2, elements similar to those of FIG. 1 are assigned like numeric designators. According to the illustrated system, a legacy OS 200 of the type that is generally associated with mainframe systems is loaded into main memory 100. This legacy OS may be the 2200 OS commercially available from Unisys Corporation, or some other similar OS. This type of OS is adapted to execute directly on a “legacy platform”, which is an enterprise-level platform such as a mainframe that typically provides the data protection and recovery mechanisms needed for applications that are manipulating critical data and/or must have a long mean time between failures. Such systems also ensure that memory data is maintained in a coherent state. In one exemplary embodiment, an exemplary legacy platform may be a 2200 data processing system commercially available from the Unisys Corporation. Alternatively, this legacy platform may be some other enterprise-type environment.

In one adaptation, legacy OS 200 may be implemented using a different machine instruction set (hereinafter, “legacy instruction set”, or “legacy instructions”) than that which is native to IP(s) 104. This legacy instruction set is the instruction set which is executed by the IPs of a legacy platform on which legacy OS was designed to operate. In this embodiment, the legacy instruction set is emulated by IP emulator 202.

IP emulator 202 may include any one or more of the types of emulators that are known in the art. For instance, the emulator may include an interpretive emulation system that employs an interpreter to decode each legacy computer instruction, or groups of legacy instructions. After one or more instructions are decoded in this manner, a call is made to one or more routines that are written in “native mode” instructions that are included in the instruction set of IP(s) 104. Such routines emulate each of the operations that would have been performed by the legacy system.

Another emulation approach utilizes a compiler to analyze the object code of legacy OS 200 and thereby convert this code from the legacy instructions into a set of native mode instructions that execute directly on IP(s) 104. After this conversion is completed, the legacy OS then executes directly on IP(s) without any run-time aid of emulator 202. These, and/or other types of emulation techniques may be used by IP emulator 202 to emulate legacy OS 200 in an embodiment wherein OS 200 is written using an instruction set other than that which is native to IP(s) 104.

IP emulator 202 is coupled to System Control Services (SCS) 204. Taken together, IP emulator 202 and SCS 204 comprise system control logic 203, which provides the interface between legacy OS 200 and commodity OS 110. For instance, when legacy OS makes a call for memory allocation, that call is made via IP emulator 202 to SCS 204. SCS translates the request into the format required by API 206. Commodity OS 110 receives the request and allocates the memory. An address to the memory is returned to SCS 204, which then forwards the address, and in some cases, status, back to legacy OS 200 via IP emulator 202. In one embodiment, the returned address is a C pointer (a pointer in the C language) that points to a buffer in virtual address space.

SCS 204 also operates in conjunction with commodity OS 110 to release previously-allocated memory. This allows the memory to be re-allocated for another purpose. SCS 204 utilizes discard queue 222 and acquire queue 224 to perform some of the release operations in a manner to be described below.

Application programs (APs) 208 communicate directly with legacy OS 200. These APs may be of a type that is adapted to execute directly on a legacy platform. APs 208 may be, for example, those types of applications that require enhanced data protection, security, and recoverability features generally only available on legacy platforms. The configuration of FIG. 2 allows these types of APs 208 to be migrated to a commodity platform.

Legacy OS 200 receives requests from APs 208 for memory allocation and for other services via interface(s) 210. Legacy OS 200 responds to memory allocation requests in the manner described above, working in conjunction with IP emulator 202, SCS 204, and commodity OS 110 to fulfill the request. Legacy OS 200 tracks the buffers 212 that have been allocated to it or one of the APs 208 using data constructs to be described further below.

The system of FIG. 2 may further support APs 112 that interface directly with commodity OS 110 as discussed above in reference to FIG. 1. Commodity OS may allocate memory buffers 114 for use by these APs. In this manner, the data processing platform supports execution of APs 208 that are adapted for execution on enterprise-type legacy platforms, as well as APs 112 that are adapted for a commodity environment such as a PC.

In one embodiment, the system of FIG. 2 further includes mass storage devices 108 that store the data utilized by commodity OS 110 and the APs 112 to which this OS interfaces. Other mass storage devices 248 are provided to store data utilized by legacy OS 200 and the APs 208 to which that OS interfaces. Mass storage devices 248 are coupled to the system via IOP(s) 246.

According to one aspect of the invention, the system of FIG. 2 provides state save capabilities. For example, legacy OS 200 utilizes state save queue 226 to create state save files 230 shown stored on mass storage devices for legacy OS 248. Likewise, SCS 204 and commodity OS 110 create state save files 250 and 252, which are shown stored on mass storage devices 108. All of these files contain data that describes the state of the system at the time of a fault occurrence. This data may be transferred to another system such as analysis system 234 so that error analysis may be performed. This will be described in detail below.

As discussed above, legacy OS 200 provides enhanced data protection and system recovery capabilities generally not available from commodity OS 110. However, the configuration of FIG. 2 poses some challenges where memory management is concerned, particularly in regards to recovery scenarios. This relates to the fact that both legacy and commodity OSes are tracking allocated memory. That is, legacy OS 200 is tracking allocation of memory buffers 212, and commodity OS 110 is tracking the allocation of all memory, including memory buffers 114 and 212. This activity must remain synchronized or “memory leaks” will occur. A memory leak is an area of memory that becomes unusable because commodity OS 110 records that the area has as been allocated to legacy OS 200, but legacy OS has lost track of that area because of some type of failure.

As an example of the foregoing, assume a failure associated with legacy OS 200 causes its memory allocation records to become corrupted. Because of failure recovery techniques, legacy OS 200 is able to recover portions of its operating environment and resume execution. Because of the corruption, however, legacy OS no longer retains a record of the allocation of one or more of the memory buffers 212. Never-the-less, commodity OS 110 retains a record of this memory allocation, and therefore will not allocate the memory to any other use. In this scenario, the buffers in question will not be used by legacy OS, and will never be re-allocated to any other purpose. Therefore, this memory “leak” results in an area of unusable memory.

The current invention addresses the problems that arise when multiple disparate OSes are executing on the same platform in the above-described manner. The invention provides a mechanism to synchronize the memory management functions of these OSes to prevent memory leaks from developing.

### II. Communication Interface

Before continuing with a description of the synchronization mechanism, interfaces between legacy OS 200 and commodity OS 110 are described. As discussed above, legacy OS 200 executes an instruction set that is adapted to run directly on instruction processors of an enterprise-type system, rather than the commodity platform shown in FIGS. 1 and 2. In one embodiment, legacy OS 200 is a 2200 operating system commercially available from Unisys Corporation that is adapted to run on a 2200-style system, also commercially available from Unisys Corporation.

When operating in a legacy environment, legacy OS 200 uses a paging mechanism to manage memory directly. That is, legacy OS has visibility into both physical and virtual address spaces. In contrast, according to the current invention, legacy OS only has visibility to the virtual address space. In one embodiment, the legacy OS uses 72-bit C pointers to address this virtual address space. Addressing within physical address space (that is, the addressing that is used to access physical memory devices) is supported by the commodity OS 110.

When executing on a commodity platform of the type shown in FIG. 2, legacy OS 200 performs memory management functions with the help of system control logic 203 as follows. When the system is being newly-initialized, system control logic 203 loads and initializes IP emulator 202. During this process, system control logic 203 also acquires the memory area that will be used to start the booting process for the legacy OS 200. System control logic 203 loads the legacy OS 200 load program into this memory area and informs the IP emulator 202 to begin execution of these instructions. This begins the legacy OS boot process.

Once the boot has begun executing on IP emulator 202, system control logic 203 provides the memory management interface between legacy OS and commodity OS. In particular, when legacy OS 200 requires memory allocation, legacy OS 200 makes a request to the IP emulator 202 which emulates the legacy OS instruction set. The IP emulator translates the request and forwards it to SCS, which may perform some additional processing. SCS 204 eventually makes a corresponding request to commodity OS 110. Commodity OS will satisfy the request to allocate memory, and will return to legacy OS 200 a virtual address pointing to the allocated memory. In one embodiment, the returned virtual address is a C pointer.

In one embodiment, legacy OS submits requests for memory allocation to system control logic 203 using an Instruction Processor Control (IPC) instruction. The IPC instruction is part of the hardware instruction set of the legacy IP on which legacy OS is adapted to execute. The IPC instruction is executed on a legacy platform to initiate various control functions in the hardware, most of which are beyond the scope of the current invention. According to the current invention, a new memory management sub-function is defined for the IPC instruction. This sub-function is used to communicate with system control logic 203. This new memory management sub-function is encoded into a predetermined function field of the IPC instruction. When legacy OS executes an IPC instruction that includes this sub-function, IP emulator 202 expects that the contents of emulated processor registers A1 and A2 contain an address that points to a memory management packet 220 in memory. In one embodiment, the contents of these registers are concatenated to form a C pointer in virtual address space that points to this packet 220. In another embodiment, the address could be passed in another manner.

According to one embodiment of the current invention, memory management packet takes the format shown in Table 1, as follows:

TABLE 1
Memory Management Packet

| | |
|---|---|
| Word | Contents |

| | | |
|---|---|---|
| 0 | Version | |
| 1 | Function | |
| 2 | Auxiliary Information | Output Status |
| 3-15 | Function Unique | |

The first column of Table 1 indicates a word position within the memory management packet, and the second column indicates the contents of the corresponding word. For instance, word 0 (that is, the first word of the packet) contains a version number. This version indicates the current revision of the packet. This version may be incremented in the future as new fields are added to the packet to accommodate new functionality in legacy OS 200 and/or system control logic 203.

The next word in the packet, word 1, provides the specific memory management function that is being issued by legacy OS 200 to system control logic 203. Word 2 includes an auxiliary information portion and an output status portion to describe whether the function completed execution successfully. Thus, legacy OS 200 will leave this field unused when a packet is constructed to be provided by legacy OS to commodity OS 110. If the Output Status value is set to a selected value, the auxiliary information indicates a status code from the commodity OS. Otherwise, the auxiliary information is zero. Finally, words 3-15 are unique to a given function, and will be described further below.

In one embodiment of the invention, each of the fields contained within memory management packet 220 are 36 bits wide to conform to a word size used by legacy OS 200. In contrast, main memory 100 of one embodiment has a word size of 64 bits. Therefore, each word of the packet uses only part of a memory word. In one embodiment, the 36 bits of a packet word are right-justified to occupy the least-significant bits of a memory word. Of course, many other embodiments are possible, including an embodiment wherein the size of the word used by legacy OS 200 and main memory 100 are the same width.

As discussed above, word 1 of the memory management packet 220 provides a function. The various functions are shown in Table 2.

TABLE 2
IPC Functions

| Function Name | Function Purpose |
|---|---|
| Acquire | Acquire an address range |
| Release | Release an address range |
| Discard | Dispose of recovered memory. |
| Set Attribute | Add an attribute to an area of previously-acquired memory |
| Clear Attribute | Remove an attribute from an area of previously-acquired |
| | memory |
| Pin | Fix the indicated range of addresses in physical memory |
| | (“Lock”) |
| Unpin | Release the “pin” on indicated range of addresses (“Unlock”) |
| Recovery Start | Legacy OS is beginning recovery of a previous session's |
| | memory |
| Recovery Complete | Legacy OS has completed recovery of a previous session's |
| | memory |
| Initialize | Fill an area of memory with the indicated bit pattern |
| Recover | Recover an area of memory allocated to a previous boot session |
| Retrieve | Retrieve a copy of an allocated area of memory |
| Get Allocation | Get allocation information for a specified memory allocation. |
| Update Allocation | Update allocation information for a specified memory |
| | allocation. |
| Reset Retrieval Point | Reset the allocation retrieval point to the beginning. |
| Get Next Allocation | Get the next allocation information from the next retrieval |
| | point. |

Note that the Discard, Recovery Start, Recovery Complete, and Recover functions are used in the alternative approach for memory recovery but not used in the embodiments of the current invention. The descriptions remain for purposes of illustrating differences between the alternative approach and the approach of the embodiments of the current invention.

Each of the functions in Table 2 performs a respective operation associated with memory management. Many of these functions operate on an entire “memory bank.” For purposes of the remaining disclosure, a memory bank refers to an area in virtual address space that may be of any specified size, is assigned the same characteristics, and is to be used for the same general purpose. For example, legacy OS may request a 32K-byte memory bank that will store data. This means that this memory bank is designated as having the characteristic of being a “data” bank and will not be used to store instructions.

Each of the IPC functions listed in Table 2 is discussed in turn in the following paragraphs.

Acquire Function

First, the Acquire function is considered. As shown in Table 2, this function is used by legacy OS 200 to acquire a contiguous range of memory in virtual address space for its own use, or for use by one of APs 208. To do this, legacy OS builds a memory management packet 220 in a predetermined location in main memory using the format shown in Table 3.

TABLE 3
Acquire Function

| Word | Content |
|---|---|
| 0 | Version |
| 1 | Function (Acquire) |
| 2 | Status |
| 3-4 | Area_Size |
| 5 | Attributes |
| 6-7 | Area_Cptr |
| 8-9 | Pattern_Cptr |
| 10 | Pattern_Length |
| 11-15 | Reserved |
| 16 | Allocation_Type |
| 17 | State_Save_Flags |
| 18 | Boot_Sequence_number |
| 19 | Domain_Number |
| 20-23 | Reserved |
| 24-25 | Lower_Limit |
| 26-27 | Upper_Limit |
| 28-29 | BCP_Cptr |
| 30-31 | Reserved |

Table 3 lists the format of memory management packet 220 when the Acquire function is specified in word 1 of the packet. As shown, words 0-2 are in the format described above in reference to Table 1, and words 3-15 are in a form specific to the Acquire function. Specifically, words 3-4 provide an indication of the size of the memory area that is to be acquired. In one embodiment, this word must contain a non-zero positive integer that specifies the number of words to be acquired. Legacy OS views these words to be of the size that conforms to that used on a legacy platform, which in one embodiment is 36 bits wide.

Word 5 of the memory management packet contains attributes that are assigned to the acquired area of memory. Use of the attributes is discussed further below.

Words 6-7, when concatenated, comprise an address provided by commodity OS 110 in response to the Acquire function. This address points to the memory area that was allocated in response to this request. In one embodiment, this pointer is a 72-bit C pointer that will be aligned on a 4K word (32K byte) memory boundary.

8-9, when concatenated, comprise an address provided by legacy OS 200. This address points to a memory buffer that contains a pattern that will be used to initialize the newly-allocated area of memory. In one embodiment, this address is a 72-bit C pointer. The length of this pattern is provided in word 10 of the packet, which must be non-zero and which must be evenly divisible into the size of the acquired memory area, as indicated by words 3-4. This pattern is only used when a corresponding “Initialize with Pattern” attribute is selected in word 5 of the packet.

As discussed above, word 5 of the packet shown in Table 3 may identify one or more attributes that are to be assigned to the allocated area of memory. These attributes are listed in Table 4.

TABLE 4
IPC Memory Attributes

| Bit Position | Attribute |
|---|---|
| 0 | Pinned in Memory |
| 1 | Initialize with Pattern |
| 2 | Include in Legacy OS State_Save |
| 3 | Candidate for a “large” underlying H/W page |

In one embodiment, word 5 is a master-bitted field. The first column indicates the bit position assigned to the attribute, and the second table column identifies the corresponding attribute. Bit 0 (the least significant bit) is set to a predetermined state if the allocated area in memory is to be “pinned” (i.e., “nailed”) in memory. When an area is pinned in memory, that area is not eligible to be paged out of main memory and stored to mass storage device(s) 248. This may be desirable, for instance, if a memory buffer is being allocated for use in performing an I/O operation.

Bit 1 of word 5 is set to the predetermined state if the allocated memory area is to be initialized with a pattern in the manner described above. As discussed above, if a memory management packet is associated with the Acquire function, and if bit 1 of the attributes field is set, words 8-9 of the packet will be set to the area in memory containing the initialization pattern, and word 10 will contain the pattern length.

Bit 2 of word 5 is set to the predetermined state if the allocated area of memory is to be included in saved state information that is collected by legacy OS 200 in the event of a failure. This saved state is information that may describe part, or all, of the state of the machine at the time the failure occurred. This information, which may include the contents of part, or all, of main memory 100, may be stored to mass storage device(s) 248 for use for debug and/or recovery purposes. More information on use of the state-save function is provided below.

Finally, bit 3 is set to the predetermined state if the memory being allocated is a candidate for a “large” underlying hardware page. When this bit is set, system control logic 203 is informed that special optimization processing is to be performed on the acquired memory. This is largely beyond the scope of the current invention.

When legacy OS 200 requests that memory be associated with one or more attributes using the above-described functionality, legacy OS and/or SCS 204 may record this attribute in their respective memory management constructs, depending on implementation. For instance, in one embodiment, SCS maintains a table or other construct that records that a particular memory area has been associated with one or more functions. These attributes are then used to perform memory management tasks. For instance, if SCS 204 is making a call to commodity OS to release an area of memory so that it may be re-allocated for a different use, and if SCS 204 determines that the area of memory is associated with the “pinned” attribute, SCS 204 will first make a call to the commodity OS to unpin that area of memory before issuing the request to release the memory. This is discussed further below.

Word 16 is input to indicate the type of the allocation. The value indicates either a simple allocation type or a BCP allocation type. For the simple type, the packet also includes lower and upper limits, but no BCP_Cptr. For the BCP allocation type, the packet also includes the BCP_Cptr, but no limits.

Word 17 contains the State_Save_Flags for the allocated memory area. If the input value is 0, no action will be taken during memory recovery with respect to the referenced memory area. If the value is 0x1, the memory area is to be released without saving the state data contained therein. If the value is 0x2, the state data contained in the memory are is to be saved but the memory area is not to be released.

Word 18 contains the boot_sequence_number. The system control services associates this boot_sequence_number with the allocated memory area.

Word 19 is the domain_number that is associated with the allocated memory area.

Words 24-25 contain the lower_limit, which is input to specify the lower limit of the memory. When the legacy OS requests memory it provides the maximum size of the memory area required. The upper and lower limits are internal to legacy OS and describe the current size of the area, or bank. The upper and lower limits of a bank can be dynamically modified. If the upper or lower limit of the bank has been changed after it was acquired the “Update Allocation Function” is called to store the new limits. These limits can be used to help decide how much of the bank should be dumped if necessary during recovery. This field is only valid for a simple allocation type. Words 26-27 contain the upper_limit, which is input to specify the the upper limit of the memory. this field is only valid for a simple allocation type.

Words 28-29 contain the BCP_cptr, which is the input C-pointer of the BCP for the memory. This field is only valid for a BCP allocation type.

Words 11-15 and 30-31 are reserved.

Release Function

The Release function is the counterpart to the Acquire function discussed above. Rather than acquiring memory, this function releases an area of memory so that it may be re-allocated for a different use. The memory management packet defined for the Release function is similar to that shown in Table 3 above. Words 0-2 provide a version, function (in this case the “Release” function), and status respectively.

Words 3-4 of the Release function packet indicate the size of the memory area that is to be released. In one embodiment, these words must contain a non-zero positive integer that specifies the number of words to be released. Legacy OS views these words to be of the size that conforms to that used on a legacy platform, which in one embodiment is 36 bits wide.

In a prior implementation, a word in the packet contained a Delayed Flag to indicate whether or not the “actual” release is to be deferred. The processing of the delayed flag is discussed further below for purposes of comparison to the embodiments of the current invention.

Words 6-7 provide the address of the area in main memory 100 that is to be released. In one embodiment, the address is a C pointer that must start on a 4K-word boundary in virtual address space.

Words 5 and 8-31 are reserved.

Discard Function

The Discard function is not used in the embodiments of the present invention. However, its function is describe below for purposes of illustrating the improvements of the current invention over the previous implementation. Generally, the discard function is used to recover and release memory after a failure occurs involving the legacy OS or its operating environment. In this type of scenario, SCS 204 will first determine that such a failure occurred. SCS will re-load and re-initiate execution of legacy OS 200. Legacy OS re-establishes its operating environment and memory map needed for that new boot session. After this occurs, legacy OS may be required to recover and release the memory that had been allocated to the previous boot session during which the failure occurred, as well as the memory allocated to one or more other previous boot sessions.

To release memory from a previous session in the above-described manner, legacy OS executes the IPC instruction with the Discard function selected. The memory management packet used for this function is similar to that employed for the Release and Acquire functions. Words 0-2 are used for version, function, and status, respectively. Word 3 indicates the size of the memory area being released. Words 4 and 7-15 are reserved, and words 5 and 6 provide the address of the area in main memory 100 that is to be released. In one embodiment, this address is a C pointer that must start on a 4K-word boundary in virtual address space.

The manner in which the Discard function is used will be discussed further below. At this time, it is sufficient to note that the Discard function operates in a deferred manner. That is, when legacy OS issues this function to SCS 204, SCS will not immediately call commodity OS 110 to release the specified memory area. Instead, SCS will create a record of this memory area on a queue or some other data structure. When legacy OS 200 indicates that a specific “Recovery Complete” time has arrived in the re-boot process, SCS is now free to make a request to the commodity OS 110 to release this memory. This will be described in detail below.

Set Attribute Function

The Set Attribute function is described in reference to Table 5.

TABLE 5
Set Attribute Function

| Word | Content |
|---|---|
| 0 | Version |
| 1 | Function (Memory Management Set Attribute) |
| 2 | Status |
| 3-4 | Data_Size |
| 5 | Attributes |
| 6-7 | Data_Cptr |
| 8-9 | Pattern_Cptr |
| 10 | Pattern_Length |
| 11-31 | Reserved |

The Set Attribute function is used to add an attribute to a previously-allocated area of memory. The attributes that may be added to the memory area are described above in reference to Table 4.

The memory management packet includes words 0-2, which are used in the manner described above. Words 3-4 indicates the size of the memory area to which the attributes will be added. In one embodiment, this field must contain a non-zero positive integer that specifies the number of words to which the attributes will be added. Legacy OS views these words to be of the size that conforms to that used on a legacy platform, which in one embodiment is 36 bits wide.

Word 5 of the packet identifies the attributes that will be added to the area of memory. This field is provided in the format described in regards to Table 4, above. Words 6-7 contain the address of the memory area to which the attributes will be added. In one embodiment, the address is a C pointer that must start on a 4K-word boundary in virtual address space.

When the “Initialize with Pattern” Attribute is selected in Word 4, the contents of Words 8-9 contain an address that points to a memory buffer. This buffer stores a pattern used to initialize the specified area of memory. In one embodiment, this address is a 72-bit C pointer. The length of this pattern is provided in Word 10 of the packet, which must be non-zero and which must be evenly divisible into the size of the memory area that is identified by Word 3. If the “Initialize with Pattern” attribute is not specified in Word 4, the pattern length in Word 9 must be zero. Words 11-31 are reserved.

Clear Attribute Function

The memory management Clear Attribute function is similar to the memory management Set Attribute function. The memory management packet used for this function is similar to that shown in Table 5. Specifically, Words 0-2 are used for version, function, and status, respectively. Words 3-4 indicate the size of the memory block for which the attributes will be cleared. In one embodiment, this field must contain a non-zero positive integer that specifies the number of words to be released. Legacy OS views these words to be of the size that conforms to that used on a legacy platform, as discussed above.

Word 5 of the packet identifies the attributes that will be cleared for the area of memory. This field is provided in the format described in regards to Table 4, above. Words 6-7 contain the address of the memory area for which the attributes will be cleared. In one embodiment, the address is a C pointer that must start on a 4k-word boundary in virtual address space. Words 8-31 are unused and reserved.

Both the Set Attribute and Clear Attribute functions may be used to set attributes on, or clear attributes from, a subset of an allocated memory area. For instance, if a 4K-word buffer in virtual address space has been previously allocated, the Set Attribute function may be used to add one or more additional attributes to a subset of the memory range allocated to this buffer. That subset may reside at the beginning, middle, or end of the buffer.

Pin Function

Next, the Pin function is described in regards to Table 6.

TABLE 6
Pin Function

| Word | Content |
|---|---|
| 0 | Version (1) |
| 1 | Function (7) |
| 2 | Status |
| 3-4 | Data_Size |
| 5 | Reserved |
| 6-7 | Data_Cptr |
| 8-31 | Reserved |

The Pin function is used to fix an address range in physical memory, as discussed above. This ensures that the area of memory remains resident and is not relocated. In other words, the allocated memory will not be paged out of main memory to mass storage device(s) 108 and/or 248. Additionally, the physical memory allocated to the virtual address space will not be changed. The Pin function may be specified for a subset of an allocated memory range.

The packet for the Pin function utilizes words 0-2 in the manner described above. Words 3-4 contain the size of the memory area that is to be pinned. In one embodiment, this field must contain a non-zero positive integer that specifies the number of words to be released. Legacy OS views these words to be of the size that conforms to that used on a legacy platform, as discussed above. Words 6-7 contain the address of the memory area that will be pinned. In one embodiment, the address is a C pointer that must start on a 4K-word boundary in virtual address space. Words 5 and 8-31 are unused and reserved.

Unpin Function

An Unpin function that is similar to the Pin function is also provided. This function releases any prior “pin” request so that the memory to be paged to mass storage device(s), or so that the physical memory allocated to the virtual memory space may be changed. The address range specified for the Unpin function may be a subset of a larger allocated memory area.

The format of the packet for the Unpin function is similar to that described above in regards to Table 6. Words 0-2 are utilized in the manner described above. Words 3-4 contain the size of the memory area that is to be unpinned. In one embodiment, this field specifies the number of words to be released. Legacy OS views these words as being of a size conforming to that used on a legacy platform. Words 6-7 contain the address of the memory area that will be unpinned. In one embodiment, the address is a C pointer that must start on a 4K-word boundary in virtual address space. Words 5 and 8-31 are unused and reserved.

Recovery Start Function

The embodiments of the present invention do not rely on the recovery start and recovery complete functions. However, for purposes of illustrating the advantages of the current invention over the previous implementation, the packets for these functions are described below. Table 7 illustrates a packet format used for a Recovery Start Function.

TABLE 7
Recovery Start Function

| Word | Content |
|---|---|
| 0 | Version |
| 1 | Function (Recovery Start) |
| 2 | Status |
| 3-15 | Reserved |

Legacy OS 200 uses the Recovery Start function to indicate to system control logic 203 that the legacy OS is beginning the task of recovering memory allocated to a previous boot session. This is done to synchronize memory allocation between legacy OS 200 and commodity OS 110 so that memory leaks do not develop. The use of this function and the procedure used to complete this synchronization are discussed in detail below.

In the packet created for this function, Words 0-2 communicate a version, function (“Recovery Start”), and status, respectively. The remaining Words 3-15 are unused, and are reserved.

Recovery Complete Function

The current system also provides a Recovery Complete function that legacy OS 200 uses to indicate to system control logic 203 that the legacy OS has completed the task of recovering memory associated with all previous sessions. After system control logic 203 receives this function, system control logic may now release any memory that was the target of either the Discard function, or alternatively was the target of the Release function that was performed with the delay flag activated. Both of those functions are deferred requests which are not completed until this Recovery Complete function is issued. This deferred operation is needed to ensure that memory leaks do not develop, as will be discussed in detail below.

The packet used for the Recovery Complete function is similar to that used for the Recovery Start function. Words 0-2 provide a version, function (“Recovery Complete”), and status, respectively. The remaining words 3-15 are unused, and are reserved.

Initialize Function

Table 8 displays the Initialize function packet format.

TABLE 8
Initialize Function

| Word | Content |
|---|---|
| 0 | Version (1) |
| 1 | Function (13) |
| 2 | Status |
| 3-4 | Data_Size |
| 5 | Attributes |
| 6-7 | Data_Cptr |
| 8-9 | Pattern_Cptr |
| 10 | Pattern_Length |
| 11-15 | Reserved |

The Initialize function is used to initialize an area of memory to the specified bit pattern. The packet for this function includes words 0-2 that are used in the manner described above. Words 3-4 indicate the size of the memory block to be initialized. This field may, in one embodiment, indicate the number of words to be initialized.

Word 5 of the packet uses the format described in regards to Table 4 to specify the Initialize attribute. Words 6-7 contain the address of the memory area that is to be initialized. In one embodiment, the address is a C pointer that must start on a 4K-word boundary in virtual address space.

Words 8-9 contain an address that points to a memory buffer. This buffer stores a pattern used to initialize the specified area of memory. In one embodiment, this address is a 72-bit C pointer. The length of this pattern is provided in word 10 of the packet, which must be non-zero and which must be evenly divisible into the size of the memory area that is identified by word 3. In one embodiment, the address stored in words 8-9 do not have to start on a 4K word boundary, but the entire block of data must have been allocated within a memory area.

If “Initialize with Pattern” attribute is not selected in word 4 when the Initialize function is specified, the identified area of memory is initialized to zeros. It is assumed that the pattern C pointer contained in words 8-9 is bound to the pattern for the entire system session.

The Initialize function may be used to initialize a subset of a larger allocated area of memory.

Recover Function

The embodiments of the present invention do not rely on the recover function. However, for purposes of illustrating the advantages of the current invention over the previous implementation, the packet for this function is described below. A Recover function is described in reference to Table 9.

TABLE 9
Recover Function

| | |
|---|---|
| 0 | Version |
| 1 | Function |
| 2 | Status |
| 3 | Previous_Size |
| 4 | Reserved |
| 5-6 | Previous_Area_Cptr |
| 7-8 | Current_Area_Cptr |
| 9-15 | Reserved |

The Recover function is used to recover a bank of memory that was allocated to a previous boot session. This function is used, for instance, to ensure that the previously-allocated bank is loaded into memory so that the state of a previous boot session can be saved for analysis purposes. This will be discussed below. Words 0-2 of the packet are employed in the manner discussed above. Word 3 provides the size of memory area that is being recovered. This size must be set to indicate that the entire memory bank is being recovered, and not a portion thereof. Words 4 and 9-15 are reserved. Words 5-6 store the address to the memory bank that is being recovered. In one embodiment, this address is a C pointer. Words 7 and 8 are an address that points to the memory buffer to which the data was recovered. In one embodiment, this is a C pointer.

When the Recover function is used, the memory area that is being recovered may still reside in virtual address space. That is, it may still be resident in main memory 100, or it may have been paged out to mass storage devices 108 and/or 248. In either of these cases, the Recover function will merely return the original virtual address from Words 5 and 6 in Words 7 and 8. That is, the memory area is still allocated and located at the previously-assigned address. In some cases, however, the memory area on which recovery is being attempted is no longer allocated. This happens, for instance, if a catastrophic system failure causes commodity OS 110 to perform a state save operation. While this is largely beyond the scope of the current invention, it is sufficient to note that in such cases, the data from the memory area in question must be retrieved from special state save files 252 that may be stored on mass storage device(s) 108. The data from these state save files 252 is retrieved and loaded into a newly-allocated area of main memory 100 for recovery. In this special situation, the original address provided by legacy OS in words 5 and 6 will be different from the address in words 7 and 8 that is returned by SCS 204 in the packet, since words 7 and 8 will now point to the newly-allocated memory area.

Retrieve Function

The retrieve function retrieves a copy of the information that is stored in the memory area pointed to by words 5 and 6 of the memory management packet. This copy is transferred to a buffer in main memory that is currently allocated to the legacy OS for use by the Retrieve function. The Retrieve function is described in association with Table 10.

TABLE 10
Retrieve Function

| | |
|---|---|
| 0 | Version |
| 1 | Function |
| 2 | Status |
| 3-4 | Data_Size |
| 5 | Reserved |
| 6-7 | Data_Cptr |
| 8-9 | Area_Cptr |
| 10-15 | Reserved |
| 16 | Allocation_Type |
| 17 | State_Save_Flags |
| 18 | Boot_Sequence_Number |
| 19 | Domain_Number |
| 20-23 | Reserved |
| 24-25 | Lower_Limit |
| 26-27 | Upper_Limit |
| 28-29 | BCP_Cptr |
| 30-31 | Reserved |

When the Recover function was used, the original data was being provided in main memory rather than a copy of the data. Thus, often times after the Recover function was issued, legacy OS may have accessed the recovered memory bank at the memory address originally allocated for that bank. In contrast, the Retrieve function retrieves a copy of a portion, or all, of the original memory bank that has been copied to a newly-allocated area in memory. The original memory bank remains allocated in memory.

The packet format for the Retrieve function is similar to that for the Recover function. Words 0-2 of the packet are employed in the manner discussed above. Words 3-4 provides the size of memory area that is being retrieved. In contrast to the Recover function, the Retrieve function may select a portion of the entire allocated memory bank to retrieve. Words 5, 10-15, 20-23, and 30-31 are reserved. Words 6-7 store the address to the memory area that is being retrieved. In one embodiment, this address is a C pointer. Words 8-9 are an address of the memory area to which the contents of the original memory area was retrieved. In one embodiment, this addressed is a C pointer.

Word 16 contains the Allocation_type, which his input to specify the type of the memory allocation. The value 0x1 indicates a simple allocation type and the packet also contains lower and upper limit values. The value 0x2 indicates a BCP allocation type and the packet will also contain the BCP_Cptr and no limit values.

Word 17 contains the State_Save_Flags which is input to specify the flags for controlling state saves for the allocated memory area. The values are as described above for the Acquire function. Word 18 contains the input Boot_sequence_number, word 19 contains the Domain_number, words 24-25 contain the Lower_limit, words 26-27 contain the Upper_limit, words 28-29 contain the BCP_Cptr, all of which are described above.

### Get Allocation

The Get Allocation function is used to retrieve the allocation information of a specified memory allocation from the infrastructure. The Get Allocation function is described in reference to Table 11.

TABLE 11
Get Allocation Function

| | |
|---|---|
| 0 | Version |
| 1 | Function |
| 2 | Status |
| 3-5 | Reserved |
| 6-7 | Area_Cptr |
| 8-15 | Reserved |
| 16 | Allocation_Type |
| 17 | State_Save_Flags |
| 18 | Boot_Sequence_Number |
| 19 | Domain_Number |
| 20-21 | Reserved |
| 22-23 | Memory_Size |
| 24-25 | Lower_Limit |
| 26-27 | Upper_Limit |
| 28-29 | BCP_Cptr |
| 30-31 | Reserved |

Words 0-2 are as described above, and words 3-5, 8-15, 20-21, and 30-31 are reserved. Words 6-7 contain the Area_Cptr, which is the area C-Pointer of the memory allocation whose associated allocation information is being requested. The C-Pointer must start on a 4KW/32KB boundary.

Words 16, 17, 18, 19, 22-23, 24-25, 26-27, and 28-29 contain the fields has have been previously described.

### Update Allocation Function

The Update Allocation function is used to update the allocation information of a specified memory allocation from the infrastructure and is described with reference to Table 12 below.

TABLE 12
Update Allocation Function

| | |
|---|---|
| 0 | Version (3) |
| 1 | Function (15) |
| 2 | Status |
| 3-5 | Reserved |
| 6-7 | Area_Cptr |
| 8-15 | Reserved |
| 16 | Reserved |
| 17 | State_Save_Flags |
| 18-23 | Reserved |
| 24-25 | Lower_Limit |
| 26-27 | Upper_Limit |
| 28-29 | BCP_Cptr |
| 30 | Update Selector |
| 31 | Reserved |

Words 0-2 are as described above, and words 3-5, 8-16, 18-23, and 31 are reserved. Words 6-7 contain the Area_Cptr, which is the area C-Pointer of the memory allocation whose associated allocation information is to be updated.

The State_Save_Flags contained in word 17 are input and are used described above. The Lower_Limit in words 24-25, upper limit in words 26-27, and BCP_Cptr on words 28-29 are as described above.

Word 30 contains the Update_Selector, which contains selector bits that specify the fields to be updated. For an allocation type of simple, the value 0x1 indicates the update is of the upper limit, and a value of 0x2 indicates that the update is of the lower limit. The value of 0x4 indicates the State_Save_Flags are to be updated. For an allocation type of BCP and an Update_Selector value of 0x8, the BCP_Cptr is to be updated.

Reset Retrieval Point Function

The Reset Retrieval Point function indicates to the system control services 204 to reset the retrieval point to the beginning of an internal allocation list. The legacy OS 200 calls this function before it begins to retrieve memory allocation for saving state data. Words 0-2 of the packet are used as previously above, and words 3-31 are reserved.

Memory Management Get Next Allocation Function

The Get Next Allocation function is used to retrieve the next allocation information from the retrieval point. The allocation information is returned in words 16-31 of the packet. The Get Next Allocation function is described with reference to Table 13 below.

TABLE 13
Get Next Allocation Function

| | |
|---|---|
| 0 | Version |
| 1 | Function |
| 2 | Status |
| 3-15 | Reserved |
| 16 | Allocation_Type |
| 17 | State_Save_Flags |
| 18 | Boot_Sequence_Number |
| 19 | Domain_Number |
| 20-21 | Memory_Cptr |
| 22-23 | Memory_Size |
| 24-25 | Lower_Limit |
| 26-27 | Upper_Limit |
| 28-29 | BCP_Cptr |
| 30-31 | Reserved |

Words 0-2 contain values as previously described, and words 3-15 and 30-31 are reserved.

Word 16 contains a returned value of the Allocation_Type of the memory allocation, which is either simple or BCP type as previously described.

Word 17 contains a returned value of the State_Save_Flags for the memory allocation.

Word 18 contains a returned value of the Boot_Sequence_Number corresponding to the memory allocation.

Word 19 contains a returned value of the Domain_Number corresponding to the memory allocation.

Words 20-21 contain a returned value of the Memory_Cptr of the memory allocation.

Words 22-23 contain a returned value of the Memory_Size of the memory allocation.

Words 24-25 contain a returned value of the Lower_Limit, and words 26-27 contain a returned value of the Upper_Limit of the memory allocation of the memory allocation. These values are only valid for a simple allocation type.

Words 28-29 contain a returned value of the BCP_Cptr for the memory allocation. This field is only valid for a BCP allocation type.

The foregoing discussion describes the IPC instruction that is used by legacy OS 200 to initiate memory management operations. In one embodiment, this instruction is part of the instruction set of an IP that would be included in a legacy platform on which legacy OS 200 is designed to operate.

When an IPC function is executed on the IP emulator 202, the memory management packet 220 is retrieved from the address of the area in memory designated by the emulated processor registers A1 and A2. The contents of the memory management packet are passed as a parameter to SCS 204. SCS utilizes this parameter to make corresponding calls via API 206 to the commodity OS 110 to initiate the requested memory management functions. In one embodiment, API 206 is the same API utilized by APs 112 when requesting memory management functions.

As discussed above, the various IPC functions are used to acquire, release, pin, initialize, assign attributes to, and remove attributes from, memory. These functions also allow legacy OS 200 to complete recovery operations during a soft reboot in a manner that ensures that memory leaks are not created. This is discussed further below.

### III. Recovery Processing

The recovery process initiated by legacy OS 200 during a soft reboot operation can be best understood by understanding the boot process generally. Assume that power is being applied to the data processing system of FIG. 2 such that a “hard” boot is being performed. In a manner known in the art, upon power-up, one or more of IPs 104 will access Read-Only Memory (ROM) or some other persistent storage device to begin execution of the Basic Input/Output System (BIOS). This code performs some testing and initialization to get the hardware running. The BIOS loads commodity OS 110 from mass storage device(s) 108 and turns over control of the system to the commodity OS. Commodity OS may then begin receiving various requests to load and execute APs 112. Commodity OS may also begin allocating memory buffers 114 for its own use, or as a result of requests received from APs 112. A “boot session” refers to the set of operations of the operation system and period that begins when a hard or soft boot/reboot commences and the next hard or soft boot/reboot.

One of the software entities that will be loaded into main memory 110 by commodity OS 110 is system control logic 203, which includes IP emulator 202 and SCS 204. After loading of this code is complete, a boot process included within SCS 204 makes requests via API 206 to commodity OS 110 to obtain the memory areas within main memory 100 where the legacy OS 200 load program will reside. SCS will then make the request to load the legacy OS load program from mass storage device(s) 108. This load program loads the legacy OS 200 and makes a request to commodity OS 110 to allow the legacy OS to begin executing on one or more of IPs 104.

Once legacy OS 200 begins executing, it must establish its own environment before it can perform other tasks. This involves acquiring large areas of memory that legacy OS 200 will use for memory management functions and for controlling and managing the execution of APs 208. The legacy OS is not considered booted until the entire environment has been established and is operational.

Legacy OS 200 acquires memory for use in establishing the environment by issuing IPC commands to SCS 203 using the Acquire function that is discussed above. SCS decodes and/or interprets the commands, and issues corresponding memory requests to commodity OS 110. For each such request, commodity OS 110 returns status, and if the request was successful, an address to the allocated memory area. This information is contained in a memory management packet 220 in the manner discussed above.

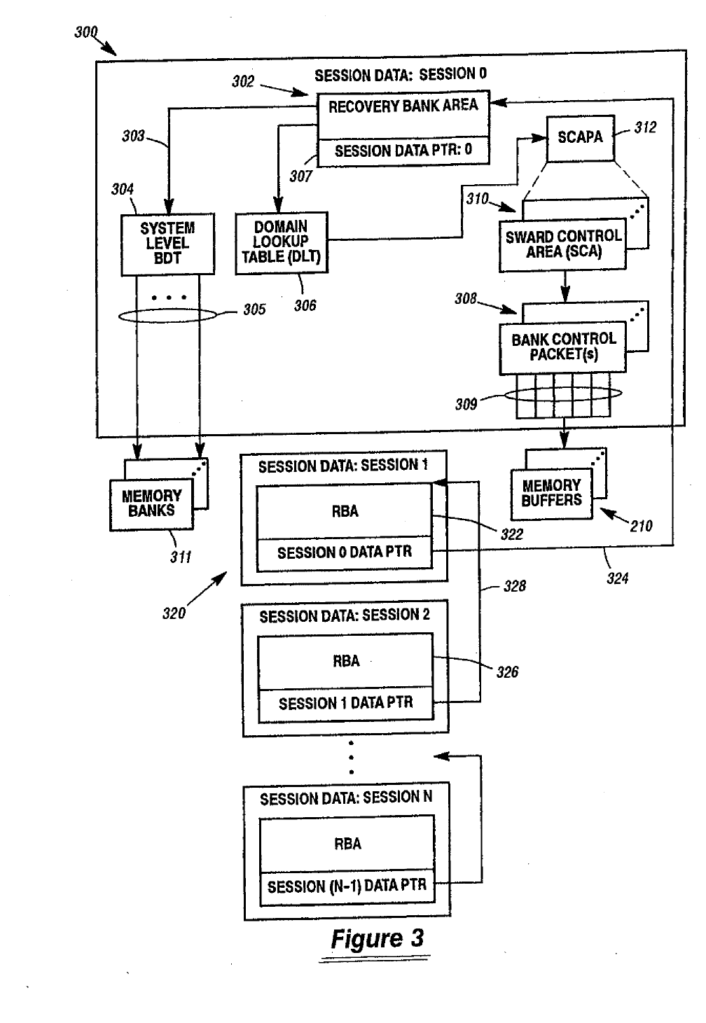

FIG. 3 is a block diagram of some of the constructs the legacy OS establishes as its operating environment during a boot session. The operating environment, which includes an extensive memory map, is referred to as “session data”. Session data is re-established each time the legacy OS 200 is re-booted. For the current example, it is assumed the system is being booted from the power-down state and is considered “session 0”. The corresponding session data 0 is shown in block 300 of FIG. 3.

In one embodiment, session data 300 includes a main Recovery Bank Area (RBA) 302. The RBA contains general operating information maintained by legacy OS 200. The RBA also contains pointers to other data constructs used by legacy OS to manage its memory areas. For instance, a system level bank descriptor table (BDT) 304 is a table that contains descriptions for all memory banks that are allocated to contain system information. System information includes any data or addresses that are being used by legacy OS 200 to establish its operating environment, including its memory map. As memory banks 311 are allocated for use by legacy OS 200, the pointers 305 to these memory banks are stored within system level BDT 304.

The system-level BDT 304 has a pointer 307 to a Domain Lookup Table (DLT) 306. The DLT is a table that contains an entry for each domain in the system. Each domain is a partition that may be allocated, and own, memory resources. Each domain may be associated with one or more processes that are executing within that domain, and that may use the memory resources allocated to the domain. Memory resources are allocated to the domain in blocks called “swards”. As a process executing in the domain needs more memory, that process is provided with memory obtained from the previously-allocated sward associated with the domain. When this memory source is depleted, another sward is allocated for the domain. Each DLT entry identifies a first sward that was assigned to the associated domain. The remaining swards for the domain are tracked by a linked list that is chained to this first sward.

The Session Data further includes a Sward (coined term) Control Area Pointer Area 312 (SCAPA). This is a system level memory bank that has entries, or descriptors, that each describes and points to a respective Sward Control Area (SCA) 310. Each SCA is a memory bank that contains descriptions of still more memory banks, shown as the bank control packet banks (BCPs) 308.

Each of the BCPs contains information on a respective one of memory banks 210 that has been acquired for use by one of APs 208. Such information may include a lower address limit, the maximum memory area size, the current size, and so on. The BCPs of one embodiment are included in a linked list that is pointed to by the SCA 310. Others ones of the structures within the session data may be arranged as linked lists.

As may be appreciated from the foregoing discussion, the session data may be thought of as a complex tree structure. The RBA 302 represents the root of this tree, and the various other structures are interconnected to the root and to one another.

In accordance with various embodiments of the invention, the BDT 304, DLT 306, SCAPA 312, SWARD 310, and BCPs 308 no longer have to be traversed. Whereas the previous approach involved constructing and traversing all the operating system structures to find all the banks that needed to be state-saved and released, the embodiments of the current invention needs only the boot sequence number in the Recovery Bank Area (RBA). Each boot session has a unique boot sequence number.

As described above, each time legacy OS 200 is loaded and begins execution, the legacy OS creates session data for that boot session. For instance, if a fault occurs during boot session 0 such that legacy OS 200 must undergo a soft re-boot (that is, a re-boot that does not require the removal of power from the system), legacy OS will establish new session data. This session data 320 for session 1 is formatted in the manner shown for session data 0.

Each time legacy OS 200 is re-booted in the foregoing manner, SCS 204 maintains the address of the RBA for the most recent session. For instance, assume an error occurred while legacy OS was booting during session 0. SCS retains the address for RBA 302, and then initiates a re-boot of legacy OS. This causes legacy OS to be re-loaded and to begin execution. Legacy OS 200 then re-establishes the session data 320 for session 1. Legacy OS next makes a call to SCS 204. In response, SCS stores the address of the RBA for session 0 within a session pointer field 307 of the RBA for session 1. This pointer, which is represented by arrow 324, will persist across additional boot sessions so that session 1 data remains linked to session 0 data even if another reboot occurs.

Next, assume yet another reboot occurs so that the current session is session 2. If the boot procedure for session 2 progresses far enough, SCS 204 will store the address of the session 1 RBA within the session data pointer field 307 of session 2 in the manner previously described. This is represented by arrow 328. Thus, all of the session data memory areas for previous boot sessions are organized into a linked list that is linked backwards in time. The RBA 302 for session 0 stores a null pointer to indicate that this RBA is at the end of the linked list.

As may be appreciated, the session data for a given session represents a very large amount of memory. Some of the constructs such as system level BDT 304 and bank control packet(s) 308 may point to many memory buffers that are being managed by the legacy OS during that session. Some constructs such as the system-level BDT 304 include pointers to areas in memory storing large amounts of code. The constructs themselves may also consume large areas of memory.

If a failure occurs such that legacy OS 200 must be re-booted, legacy OS 200 cannot directly re-use the memory allocated to a previous session, but instead will acquire new memory for use during that current session. Therefore, it is important that legacy OS release all memory that was used for the previous session so that it becomes available to be re-allocated by the system. Because commodity OS 110 has no visibility into a re-boot situation involving legacy OS 200, legacy OS and system control logic 203 must ensure that all memory from the previous boot sessions is released. If the release is not completed successfully, the memory allocated to those previous sessions remains designated as allocated by commodity OS 110, but is unusable by legacy OS 200 and its associated APs 208 such that one or more memory leaks will develop.

To prevent the development of memory leaks, a recovery process must be initiated each time the legacy OS 200 is re-booted. This recovery process occurs generally as follows. Assume that several failures occurred in succession during boot sessions 0 and 1. This resulted in the creation of multiple session data memory areas. These two session data areas are linked together in a linked list in the manner shown in FIG. 3. It will be assumed for this example that none of the memory allocated to any of these previous boot sessions has been released.

Assume further that legacy OS has been re-loaded and has begun executing during a next boot session, which is session 2. During this boot session, legacy OS 200 completes creation of its session data 326 for this session.

After the session data is constructed, legacy OS begins recovery processing. Initiation of this process is signaled by the legacy OS executing the IPC instruction with the Recovery Start function selected. This indicates that legacy OS is ready to begin recovering and/or discarding the memory allocated to the previous boot sessions 0 and 1. The Recovery Start function informs system control logic 203 that recovery is being initiated, and causes the system control logic to store the pointer to the RBA for the previous boot session in the session data pointer field 307 for the current boot session.

Upon completion of execution of the Recovery Start function, legacy OS 200 retrieves the newly-stored address of the RBA for the most recent boot session prior to the current boot session. This address is retrieved from the session data pointer field 307 of the current session data. For example, if the current session is session 2, legacy OS retrieves the address of the RBA for session 1 from the session data pointer field 307, which is represented by arrow 328.

Once the address for the RBA of the previous boot session is obtained, legacy OS attempts to recover a copy of the session data for the previous boot session 1. To do this, legacy OS executes the IPC instruction with the Retrieve function selected. Words 5 and 6 of the memory management packet for this function contain the address, in virtual memory space, of the memory area being retrieved. In this instance, this address is the address of the RBA. The size of the memory area being retrieved, which will be the predetermined size of the memory area containing the RBA, is stored within Word 3 of this packet.

The issuance of the Retrieve function by legacy OS causes SCS 204 to make a call to commodity OS 110 to allocate a memory buffer of adequate size. SCS 204 also makes a call to commodity OS to page the original page(s) storing the RBA into main memory, if necessary. SCS 204 then copies the data from the original page(s) into the newly-allocated buffer and returns the address of the newly-allocated buffer containing the RBA copy back to legacy OS. In one embodiment, this address is stored in words 7 and 8 of the memory management packet, as described above.

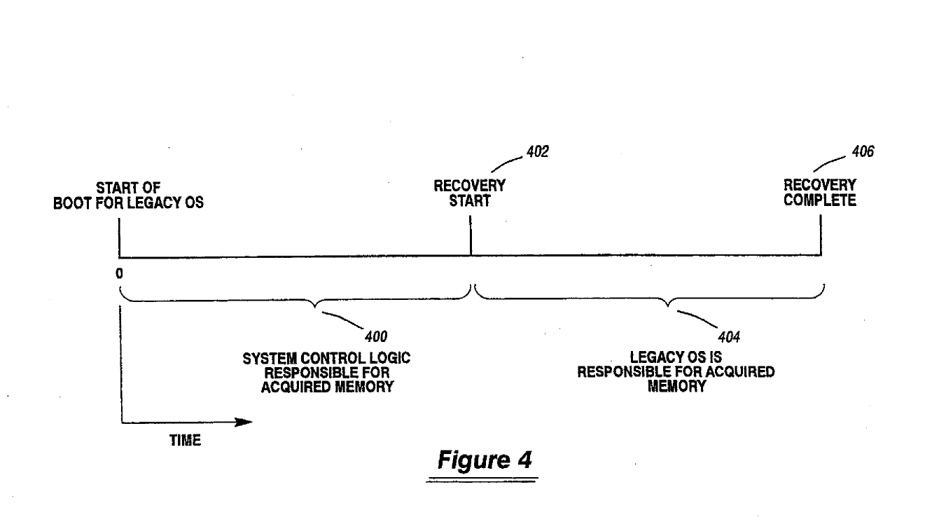

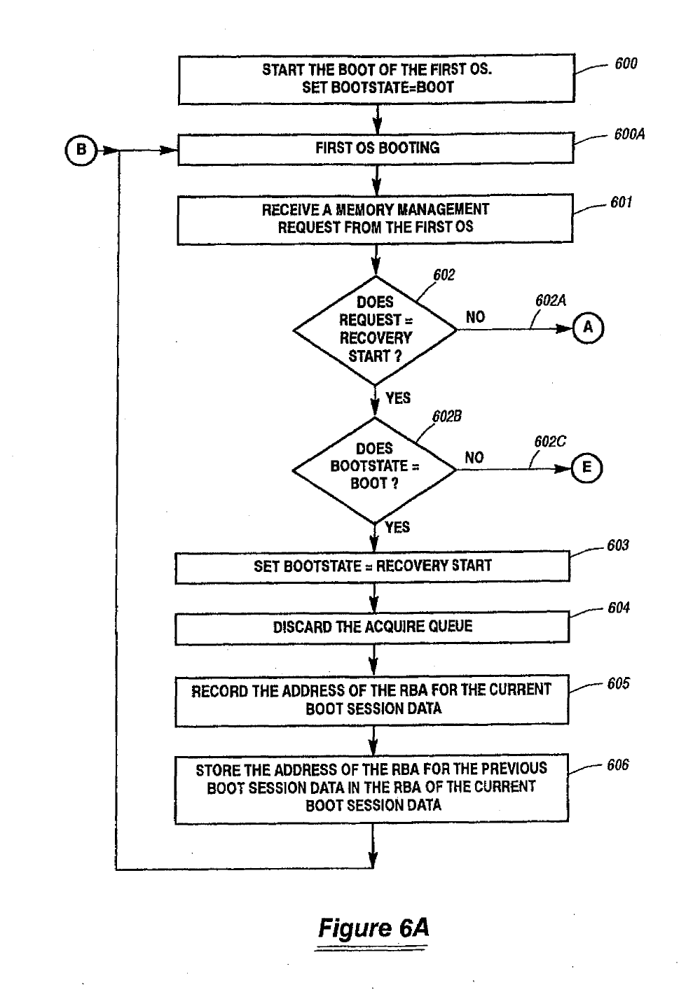

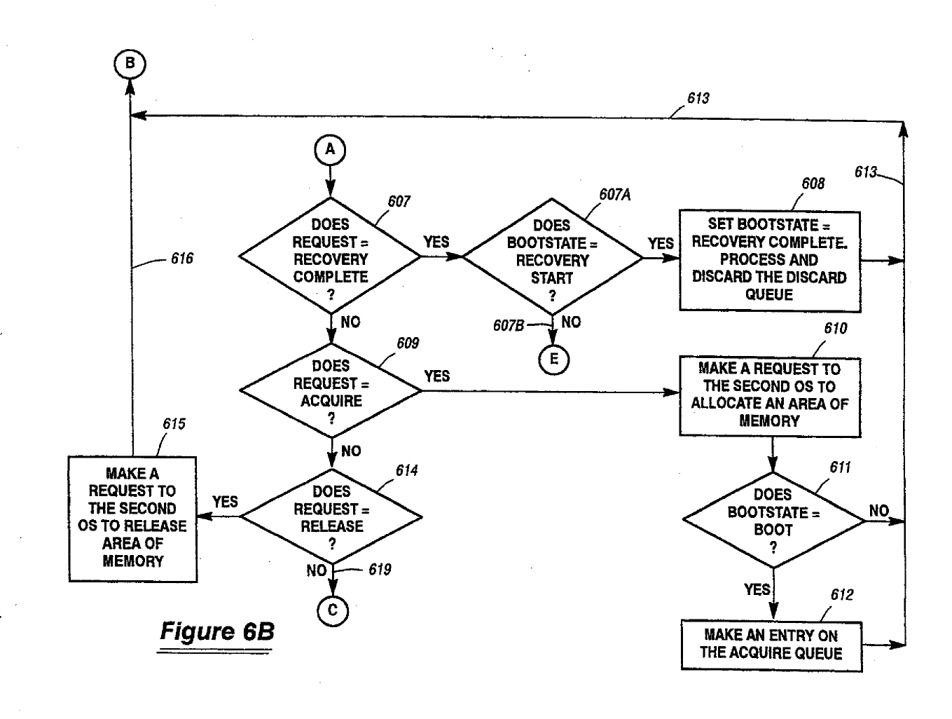

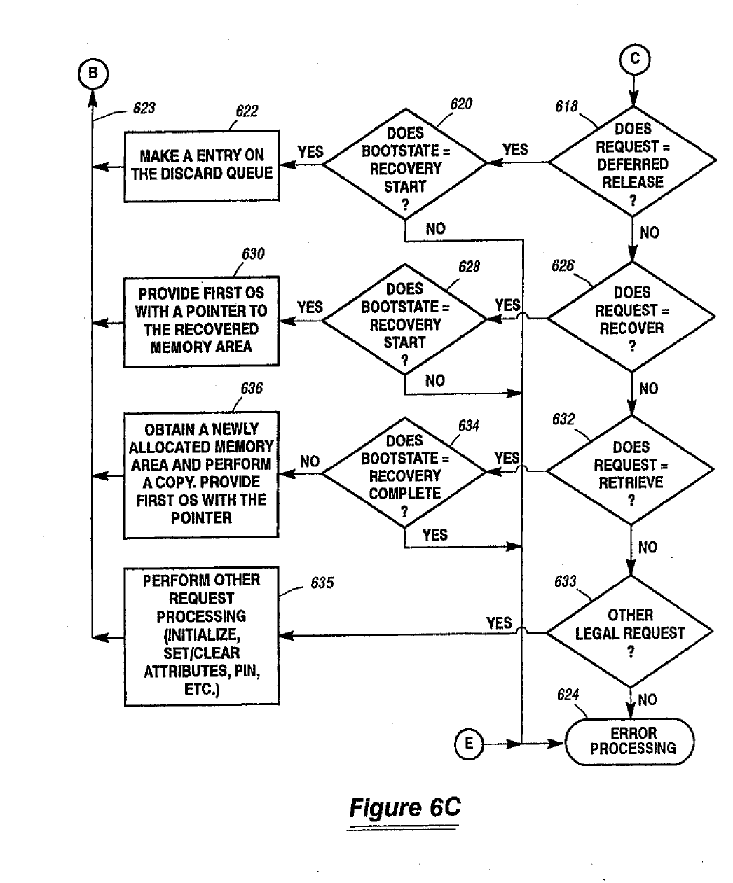

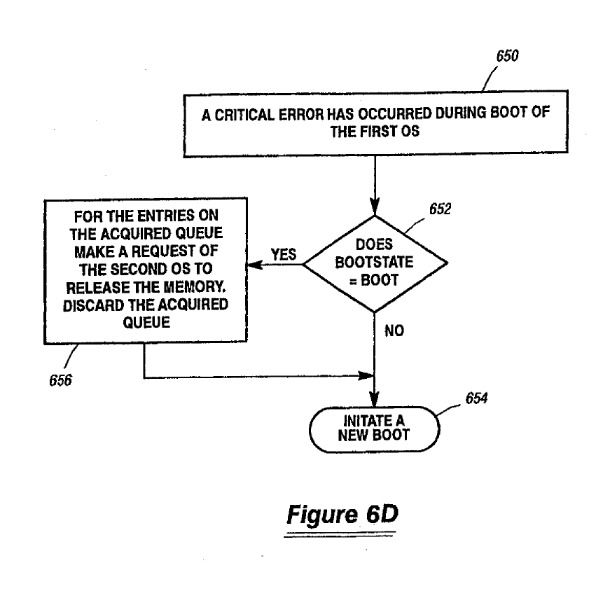

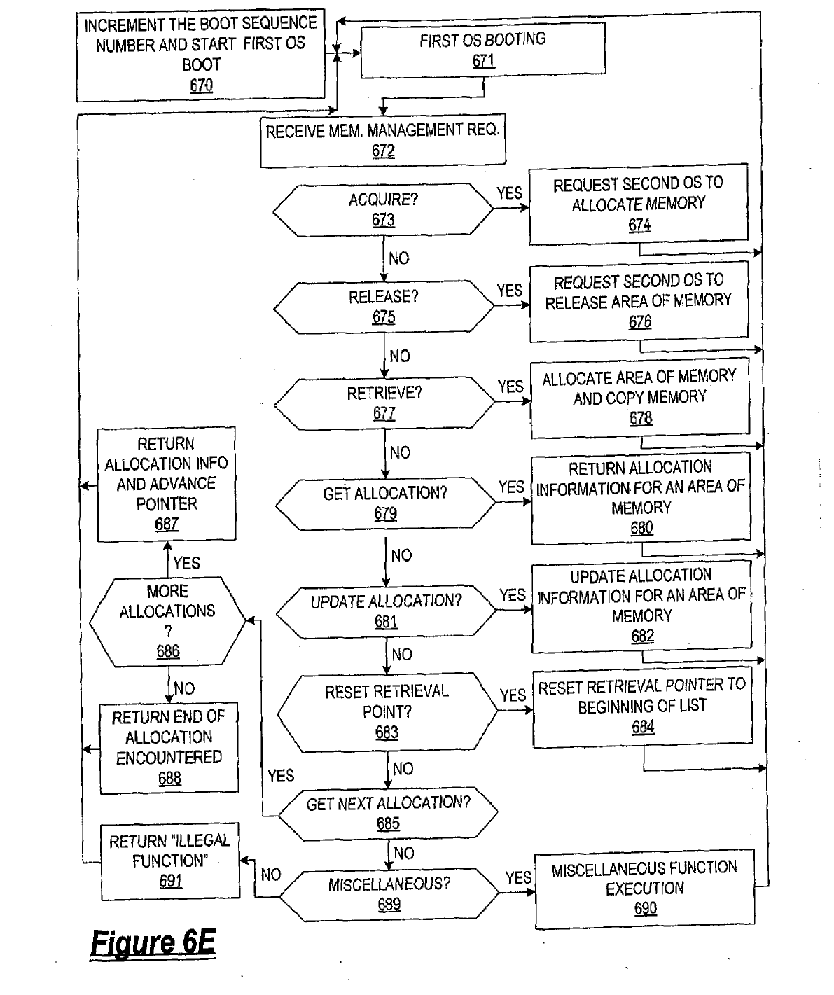

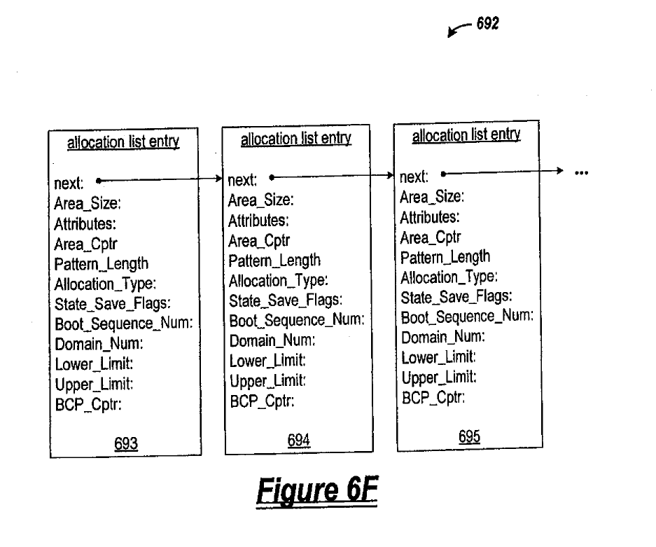

The following paragraphs, along with the description of FIGS. 4, 5, and 6A-D describe the alternative approach for recovery. For embodiments of the present invention, reference is made to FIGS. 6E-F and 7D.

When legacy OS receives the response to the Retrieve function, legacy OS obtains the address of the copy of the RBA from words 7 and 8 of the packet. Legacy OS uses this copy to extract pointers to other constructs included in the session data. For instance, legacy OS retrieves the pointer to the system level BDT 304. In a manner similar to that described above, legacy OS issues the Retrieve function to retrieve a copy of the system level BDT for session 1.

Using the Retrieve function in the foregoing manner, legacy OS 200 retrieves a copy of each of the constructs included in the session data for session 1. Once the session data has been reconstructed, legacy OS traverses through each of the constructs to process each of the memory areas pointed to by the construct. For instance, legacy OS 200 may traverse through a linked list maintained by system level BDT 304 to obtain pointers to each of the memory banks 311 pointed to by this construct. As each entry in the linked list is encountered, legacy OS performs processing related to this memory bank. The processing either simply releases that bank (e.g., using the Discard function) so it may be re-allocated for other purposes, or saves and then releases the state of that memory bank in a manner to be described below. If may be desirable to save the state, for instance, if the data is to be analyzed for debug purposes.

Before continuing, it may be noted when legacy OS 200 is processing the memory banks pointed to by the session data, such as memory banks 311, legacy OS is processing the original memory bank, rather than a copy of that bank. This will be discussed further below.

When all memory banks that are pointed to by the session data (e.g., memory banks 311 and all memory banks containing buffers 210) have been the target of a state save operation and/or have been discarded, the memory containing the session data itself may be processed in the same way. That is, each of the memory banks that were allocated to contain session data 1, 320, may be saved and then discarded, or simply discarded. These banks may be located because their addresses are contained within the system level BDT 304 for that session.

Recall that when the legacy OS 200 is processing the session data for any given session, it is working from a copy of that session data. That is, it is using a copy to release the originally-allocated memory banks. When all memory banks used to store the original session data for session 1 have been discarded, the copy of the session data may next be released. Before this is done, legacy OS 200 retrieves the session data pointer for the next most recent session data. In the current example, this is the pointer to session 0 data, which is represented by arrow 324. Then legacy OS 200 may release the memory (e.g., using the Release function) that was allocated to store the copy of session data 1.

Next, legacy OS uses the retrieved pointer to the next most recent session data (i.e., session data 0) to repeat the process. In this manner, legacy OS 200 systematically traverses the linked list of session data areas, retrieving a copy of the session data area, releasing all of the memory pointed to by this session data, releasing the original memory storing that was allocated to store the session data, and finally releasing the memory allocated to store the copy of the session data. When the legacy OS 200 finally encounters the session data area storing a null value in the session data pointer field, all memory has been processed.

When the legacy OS encounters the null value in a session data pointer field, the legacy OS may have to impose a delay before the recovery process continues. This is necessary so that any required state save activities needed to retain part, or all, of the execution state will be completed.

Eventually the legacy OS 200 receives an indication that all state save operations have been completed. This triggers execution of the IPC instruction with the Recovery Complete function selected. The Recovery Complete function provides an indication to system control logic 203 that the recovery operation is completed from the legacy OS' viewpoint. Legacy OS may then store a null value in the session data pointer for the current boot session. This provides a record that all memory for all previous boot sessions prior to the current boot session has been recovered. If a re-boot must be performed in the future, legacy OS must only process the previous session 2 data, since processing for session 1 and session 0 data has been completed.

With the foregoing available for discussion purposes, a more detailed description of the way in which memory is handled during the recovery process according to the alternative approach is provided in reference to FIG. 4.

FIG. 4 is a timeline illustrating events that occur during a boot session for legacy OS according to the alternative approach for handling recovery. At time 0, SCS 204 loads, and initiates execution of, legacy OS 200. During the time period 400 prior to Recovery Start time 402, legacy OS 200 is performing the processing needed to build the session data for the current boot session. Until this data is completed, the legacy OS 200 cannot proceed to the recovery phase of the boot process.

As shown in FIG. 3, the session data includes complex, inter-related data structures. Legacy OS 200 does not necessarily build these structures from the “top down”. As an example, at a given instant in time, legacy OS 200 may be in the process of constructing one or more bank control packets 308, the pointers to which are not yet stored within an associated SCA 310. If a failure occurs at that moment in time, the interconnections between the various constructs of the current session data are not in place to be used to recover memory in the manner described above. In other words, if a reboot occurs, legacy OS will not be able to use the session data area to locate all memory that was allocated to the boot session, and some allocated memory could therefore become a “leak”. To prevent this from occurring, some other mechanism is needed to track the memory being allocated to the boot session during time period 400.

To address the above-described situation, SCS 204 is made responsible for recovering all memory that was acquired for the current boot session during time period 400. That is, each time legacy OS 200 uses the Acquire function to obtain memory, SCS 204 records the address and size for the allocated memory area. This information is added to an entry of an acquire queue 224 (FIG. 2). In this manner, acquire queue 224 tracks all memory that was allocated on behalf of the legacy OS 200 for the current boot session.

If no error sooner occurs, the boot of legacy OS 200 will complete enough of the construction of the data structures contained in the session data so that all pointers are in place. At this time, the legacy OS is able to locate all of the memory that was allocated to it during the current boot session merely by gaining access to the RBA. Therefore, the legacy OS may now be responsible for recovering and releasing all memory allocated on its behalf during the current boot session. At this time, the legacy OS executes the IPC instruction with the Recovery Start function selected.

When SCS 204 detects that legacy OS executed the IPC instruction with the Recovery Start function selected at time 402, SCS may discard the acquire queue 224. This may be accomplished by making a request to commodity OS to release the memory allocated to this queue. Because legacy OS 200 has reached a stage in the boot process that allows it to locate all of the memory allocated to it for the current session data, if a failure occurs during time period 404, legacy OS 200 will recover this allocated memory itself. This will be accomplished during a subsequent re-boot process in the manner described above.

In some cases, SCS 204 will not detect the execution of the IPC instruction. Instead, SCS 204 will detect that legacy OS somehow failed during the boot process such that the Recovery Start time 402 was never reached. In this case, legacy OS may not be capable of recovering all memory that was allocated to it during the current boot session. Therefore, to prevent the development of memory leaks, SCS 204 processes all entries on the acquire queue 224. For each such entry, SCS makes a request to commodity OS 110 to release the area of memory that was acquired on behalf of the legacy OS during the current boot session. When all such memory is released successfully, SCS 204 may initiate another re-boot attempt for the legacy OS.

The prior recovery procedure, as described above, thereby involves a two-step boot process. During time period 400, SCS 204 tracks all acquired memory so that SCS may release the memory should a failure occur prior to Recovery Start time 402. In contrast, all memory acquired after time period 402 on behalf of the legacy OS will be released by the legacy OS during a subsequent boot session.

Next, the manner in which memory is processed during time period 404 is considered. During time period 404, legacy OS processes any unreleased memory areas that were allocated for its use during any previous boot session. To enable this, when legacy OS 200 executes the IPC instruction with the Recovery Start function selected, SCS 204 may store an address of the RBA for the most recent boot session prior to the current boot session in the session data pointer field of the current session data. SCS will only store a pointer in this manner if that previous boot session has not yet undergone recovery processing. If no previous boot session exists, or if recovery processing has already been completed for that previous boot session, SCS 204 stores a null value in the session data pointer field at this time.

Next, legacy OS 200 retrieves any pointer provided by the SCS 204. This pointer is an address to the previous session's RBA, as discussed above. Legacy OS then begins the process of reconstructing a copy of the various constructs included in the session data of the previous boot session. This is accomplished in the foregoing manner. When this reconstruction is complete, legacy OS begins traversing these constructs, including those shown in FIG. 3, to process each memory bank to which one of these constructs points. This processing may involve saving the state of the memory bank, and then releasing that bank for re-allocation. Alternatively, the memory bank may be released without performing a state save operation. Whether a memory bank is simply released, or the contents of that bank are to be saved first prior to the bank's release, is determined by control bits in the control structure that describes the memory bank. The saving of the contents, and/or release, of a memory bank occurs generally as follows.

The simplest case is considered first. This involves the scenario wherein all memory buffers associated with all session data areas are to be discarded without performing any state save operations. Legacy OS will determine a memory buffer is to be released without performing a state save operation via the state of control bits that are associated with each memory buffer, as discussed above. When the legacy OS 200 determines that a memory bank is to be released, legacy OS executes the IPC instruction with the Discard function selected. The memory management packet for this function includes the address to be discarded in Words 5-6. The size of the memory to be discarded is provided in Word 3.

When SCS 204 detects that the legacy OS has issued the Discard function in the above-described manner, SCS defers this request. This means that SCS does not immediately issue a request to commodity OS 110 to release that memory. Instead, SCS 204 builds an entry on the discard queue 222 (FIG. 2). This entry contains the size and address of the memory area to be released, as obtained from the memory management packet of the IPC instruction. This entry provides a record that the described memory area is to be released at a future time.

In the foregoing manner, each time legacy OS 200 issues the Discard function to release a memory area without performing a state save operation, SCS places another entry on discard queue 222. This queue may contain many entries representing a very large portion of main memory 100, particularly if multiple session data areas are being processed by legacy OS 202 during time period 404.

Recall that the processing performed to release memory allocated to store the session data is performed using a reconstructed copy of this session data. That copy is created using the Retrieve function, as described above. This copy is needed so that all of the original memory storing the original session data may be released while still retaining copies of the pointers needed to continue recovery processing.

After each session data area is processed, the memory allocated to store the reconstructed copy of the session data area must also be released. To do this, legacy OS 200 executes the IPC instruction with the Release function selected, and with the Delayed flag deactivated. The causes the memory allocated to store the copy to be immediately released.

After all session data areas are processed without failure in the foregoing manner, legacy OS executes the I PC instruction with the Recovery Complete function selected, as mentioned above. This marks the Recovery Complete time 406. After this point in the boot process, legacy OS may not use the discard function to release any additional areas of memory.

In response to receipt of the Recovery Complete function, SCS 204 may now begin issuing requests to release the memory areas represented by the entries on the discard queue 222. Specifically, for each such entry, SCS makes a call to commodity OS 110 via API 206 to release the described memory area. If commodity OS 110 completes a request successfully, the released memory is available for re-allocation to another process. This ensures that the memory area does not become a memory leak. When SCS processes all entries on the discard queue 222, recovery processing is complete. SCS may then release the memory allocated to the discard queue via another request to commodity OS.

The deferred release process, as described above for the alternative approach, is used to release the memory for one or more boot sessions for the following reason. The various constructs represented by the session data are very large and complex. Requiring legacy OS to track how far the recovery process had proceeded would be too complex, time-consuming, and would require too much memory. Therefore, this requirement is not imposed. Legacy OS therefore has no record of which memory banks were, from its viewpoint, released at any given time in the recovery process. As a result, if a failure occurs during the recovery process such that another re-boot operation must be initiated, legacy OS 200 is required to begin the recovery process from the very beginning (i.e., by processing the most recent previous boot session data.)

As an example of the foregoing, assume that legacy OS is processing a chain of three session data areas. Legacy OS is half-way through processing of the second session data area when a fatal area occurs such that legacy OS must be re-booted by SCS 204. When legacy OS once again is at a point where it may attempt the memory recovery process, legacy OS has no visibility as to how far it progressed during the previous failed recovery attempt. Therefore, legacy OS must start from the “beginning”. That is, it must obtain the address of the session data area for the most-recent previous session. According to the current example, this session data area will now be part of a chain that includes four (rather than three) such areas. Specifically, the chain includes the three areas for which recovery was being attempted when the most recent failure occurred, as well as the session data for the boot session that was active at that time. Legacy OS will again start with the session data for the most recent previous session and work backwards in time until it reaches a session data area with a null value in the session data pointer.

Another reason memory is not released immediately during a recovery attempt is because of the way the memory constructs within the session data areas are interconnected. Various pointers link the constructs, as well as entries within the constructs. Releasing any of the memory prematurely would destroy the linked lists, making it difficult or impossible to continue or re-initiate a recovery attempt if a failure occurred mid-way through the recovery process.

As mentioned above, the foregoing discussion focuses on the least complex recovery scenario wherein all memory banks from previous boot sessions are simply discarded, making them available for re-allocation. In some cases, the contents of those memory banks must be saved during a state save operation before those banks are discarded. This process is initiated by the legacy OS executing the IPC instruction with the Recover function selected. The address to be recovered is contained in Words 5-6 of the memory management packet, and the size of the memory bank to be recovered is contained in Word 3 of this packet. In the alternative approach, the Recover function will only recover an entire allocated memory bank.

As discussed above, the memory bank that is being recovered may still reside at its previous location in virtual address space, which is the address contained in the packet. In this situation, SCS 204 makes a request to commodity OS 110 to ensure that the memory bank is paged into main memory, and the same address contained in the packet is also returned to legacy OS in the packet.

In some cases, the memory bank that is being recovered may no longer reside within virtual address space. This occurs in a scenario wherein a critical fault occurred that caused commodity OS 110 to halt execution. Before this halt occurs, commodity OS stores the entire state of the system to the commodity OS state save files 252 on mass storage device for commodity OS 108. The commodity OS then halts. In this case, it is generally necessary to perform a cold boot, which involves re-initializing the hardware, and re-loading and re-initiating execution of the commodity OS. Booting of legacy OS 200 then proceeds according to the process described above.

After a cold re-boot occurs in the aforementioned manner, when the legacy OS 200 issues the Recover function in attempt to recover memory that was the target of the commodity OS' state save operation, the memory contents must be retrieved from state save files 252. To do this, SCS 204 acquires a new memory bank from commodity OS and copies the contents of the old memory bank from state save files 252 into this newly-acquired memory area. SCS 204 then provides the address of this new-acquired memory area to legacy OS in the packet.

After legacy OS receives the response to the Recover function, legacy OS may access the recovered data using the pointer contained in Words 7-8 of the packet. In one implementation, legacy OS uses the Acquire function to allocate another state save buffer in memory. Legacy OS copies the contents of the recovered memory bank into the newly-allocated buffer and places an entry on state save queue 226 in main memory for this buffer. A state save process of legacy OS will eventually process this queue entry by copying the contents of the newly-allocated buffer to state save files 230 that are contained on mass storage device(s) 248. These state save files are used to perform “debug” operations related to previous failures and/or to perform analysis involving prior boot sessions. This will be discussed in detail below.

Finally, legacy OS 200 uses the Release function with the Delayed flag set to release the recovered memory bank. This causes SCS 204 to add an entry to Discard queue 222 so that the recovered memory bank will be discarded if Recovery Complete time 406 is reached.

Legacy OS 200 will receive an acknowledgement from the state save process that indicates when contents of a buffer have been copied to mass storage device(s) 248 for state save purposes. At this time, legacy OS may use the Release function to release the memory area containing the buffer that stores the copy of the memory contents. The Delay flag need not be activated for this Release function, since the allocated buffer contains only a copy of the recovered data, and is not the original buffer. In contrast, the recovered memory buffer is released in a deferred manner, as set forth in the foregoing paragraph.

Legacy OS cannot issue the Recovery Complete function until legacy OS has received an indication that the state save function has completed successfully for each memory bank that is to be recovered and saved in the above-described manner. This ensures that SCS 204 retains a copy of all data that is to be saved until the state save operation successfully completes. Otherwise, data may be lost if the state save operation or some other aspect of the recovery does not complete successfully.

The approach described above recovers a memory bank, and then copies the contents of that memory bank to a newly-acquired buffer. In an alternative approach, it is possible for legacy OS to create an entry on state save queue 226 that references the address of the recovered memory bank rather than the copy thereof. The state save operation would occur directly from the recovered memory bank. This eliminates the need to perform the copy operation. In this alternative approach, legacy OS will not release the recovered memory bank until the state save operation for that bank is completed. The release will occur using the Release function with the Delayed flag set, as was the case in the former approach.

After legacy OS receives an indication that the state save operation completed for each memory bank that was queued to state save queue 226, legacy OS will issue the Recovery Complete function to SCS 204. SCS may then release all banks on the state save queue 226, including any bank allocated during this boot session for use during a Recover function to recover data from state save fillies 252.

The above discussion provides several alternative ways to handle memory that was allocated to a previous boot session. In a first case, the originally-allocated memory banks are merely discarded. In another case, the contents of originally-allocated memory banks are the target of a state save operation that is completed before the memory bank is discarded. In yet another case, some of the banks may be saved and discarded, and others may be merely discarded.

As discussed above, legacy OS 200 determines which memory banks to save using controls bits associated with each bank. In one embodiment, the control bits are flags that are retained in the corresponding session data. These flags may be set on a bank-by-bank basis, and/or may be set on a domain basis. For instance, it may be determined that all memory banks allocated to a particular domain as recorded in DLT 306 must be the object of a state save operation if a re-boot occurs. In one implementation, the domain flags, which are maintained in the DLT 306, may override any other flags that are bank-specific. According to another aspect of the invention, the state save flags are only used If one or more “boot keys” indicate state saves operations are to occur. The boot keys are operator-selected designators that are used to control various aspects of the system. These boot keys may be saved within the session data. If the boot keys indicate no state save operations are to occur, the state save flags contained within the session data are ignored.

In the approach described above, the state save flags are retained by legacy OS 200 in the session data. SCS 204 may likewise retain state save flags. Recall that when legacy OS 200 uses the Acquire function to acquire memory, the packet for this function contains attribute flags. These attributes may likewise be set after memory is allocated using the Set Attribute function. One of these flags is the state save flag that is assigned to those memory banks that are to be the target of a state save operation.

The SCS 204 may create a state save file if a failure occurs before Recovery Start time. That is, as SCS is processing each entry on the acquire queue 224, if the entry is associated with a memory bank that has the state save flag set, the contents of the memory bank can be saved to mass storage 108. Once the bank has been saved, a request is issued to commodity OS 110 to release that bank. This capability is useful to save the state of memory banks during time sequence 400. It may be noted that these state save files are located in mass storage devices 108 for the commodity OS whereas the legacy OS 200 state save files are stored in legacy OS mass storage devices 248.

Yet another kind of state save process may be initiated, as was previously described in regards to recovery processing. This involves the situation wherein a critical failure affects operation of commodity OS 110 such that its operation must be halted and a cold boot initiated. In this case, before commodity OS halts, it will save the state of the entire system to state save files 252 on mass storage devices 108. If this type of failure occurs, during subsequent recovery processing initiated for legacy OS according to FIG. 4, data is read from state save files 252 when a Recover function is used. The recovered data may then be stored to one of the state save files 230 on mass storage devices 248 so that it becomes available for analysis during the state save process to be described below.

In each of the three types of state save scenarios discussed above, data is saved to a respective one of state save files 230, 250, and 252 along with an indication of the address at which the saved data was stored. For instance, for each predetermined block of data that is stored to a state save file, the address at which this data resided within main memory 100 is stored along with that data portion. In one embodiment, this address is retained in a header stored along with the data. This address may then be used to re-create the execution environment of system 201. According to one aspect of the invention, the address that is stored along with the data is a virtual address that is used to recreate the virtual address space of system 201 so that analysis may be performed, as will be discussed in detail below.

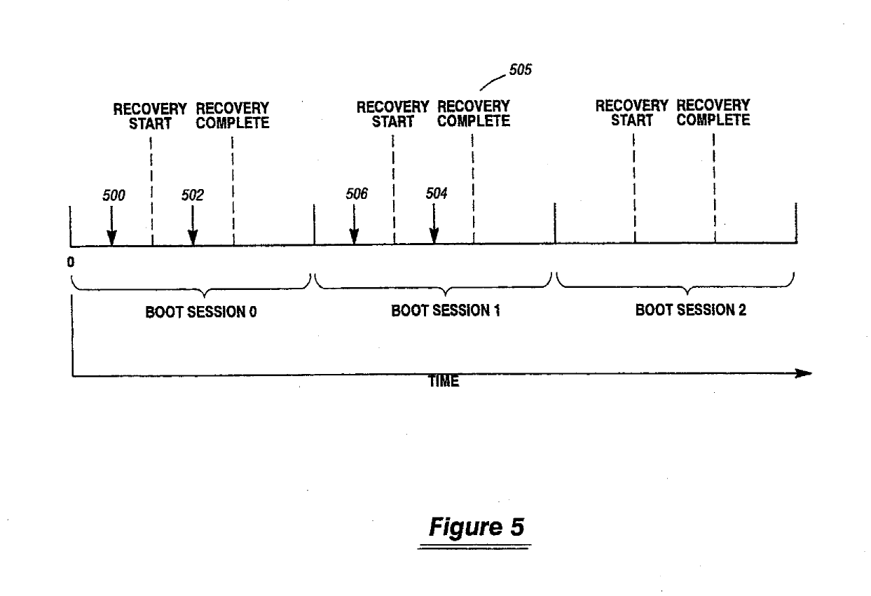

The foregoing describes an alternative approach for performing recovery in a manner that eliminates the occurrence of memory leaks. Various recovery scenarios according to that approach may be considered in reference to FIG. 5, as follows.

FIG. 5 is a timeline that represents multiple successive boot attempts for legacy OS according to the alternative approach for handling recovery. Boot sessions 0, 1, and 2 occur during successive time intervals. Each such interval includes a recovery start and complete time corresponding to the time at which legacy OS issues the Recovery Start and Recovery Complete functions, respectively. Various recovery scenarios are described in regards to this timeline.

First, assume a failure occurs at time 500 during boot session 0. At this time, the session data 0 has not yet been completely constructed. Therefore, SCS 204 is responsible for releasing all acquired memory prior to the initiation of boot session 1 Therefore, when boot session 1 is initiated, and assuming recovery start time is reached, legacy OS will not have any prior session data to process or recover. A “null” pointer will be stored as the session data pointer of the RBA for session 0. Therefore, legacy OS will issue the Recovery Start function and the Recovery Complete function in a “back-to-back” manner without the need to perform any interim processing.

Next, assume a failure instead occurs at time 502 during boot session 0 after legacy OS issues the Recovery Start function. As a result, SCS 204 initiates boot session 1. Assuming the recovery start time for boot session 1 is reached. Therefore, legacy OS 200 obtains the address for the session 0 RBA from SCS 204 and performs memory recovery in the manner described above. If this completes successfully, the session data for boot session 1 will store a Null pointer in the pointer to the previous session data.

Next, assume that during recovery of session 0 data, a second failure occurs at time 504 prior to recovery complete time 505. SCS 204 therefore initiates boot session 2. If recovery start time is reached during boot session 2, legacy OS obtains the pointer to the RBA for session 1 data. Legacy OS must perform recovery operations for both session 1 data and session 0 data.

Consider yet another scenario wherein a first failure occurs at time 502 during boot session 0. Because of this failure, legacy OS enters boot session 1. Recovery start time for boot session 1 is not yet reached at the time legacy OS experiences another failure at time 506. SCS 204 therefore recovers all memory associated with boot session 1, and legacy OS enters boot session 2. If recovery start time is reached this time, legacy OS must now perform recovery for session 0 but not session 1, since memory associated with session 1 was recovered by SCS 204 prior to the start of boot session 2. The memory allocated during boot session 0 is considered the responsibility of legacy OS since recovery start time was reached during boot session 0 before the failure occurred.

As may be appreciated from FIG. 5 and the associated examples, an almost infinite number of recovery scenarios are possible according to the current invention.

FIGS. 6A, 6B, and 6C are a flow diagram of a method of booting an operating system according to the alternative approach described above. In that approach, the method is executed by SCS 204 during a re-boot of the legacy OS. FIG. 6D is a flow diagram that illustrates the method that is executed if a critical error occurs any time during the booting of the first operating system according to the alternative approach. FIG. 6E is a flow diagram of a method of booting an operating system according to embodiments of the current invention.

The diagrams of FIG. 6A-6C refer to a SCS BootState variable that corresponds to the timeline in FIG. 4. If this BootState variable is set to “Boot”, processing is occurring within time interval 400 of FIG. 4. If the BootState variable is set to “RecoveryStart”, processing is occurring within time interval 404. If the BootState variable is set to “RecoveryComplete”, processing is occurring after the Recovery Complete time 406.

The method of FIGS. 6A-6C is initiated by starting execution of a first OS on the system which may be similar to that of FIG. 2 (600). At this time, the BootState variable is set to “Boot”. According to the implementation described above, this first OS is legacy OS 200.

Once booting of the first OS is initiated, SCS 204 is in a state wherein it waits for requests from the first OS and monitors the system for error conditions. This state is represented by block 600A of FIG. 6A. Requests will be received when the first OS executes the IPC instruction with one of the functions described herein selected. The receipt of such a request is represented by step 601.

One of the request types issued via execution of the IPC instruction may indicate that recovery is being started (602). In one embodiment, this type of request is issued when the Recovery Start function is selected during IPC instruction execution. When SCS 204 detects this type of request, it is first determined whether the BootState variable is set to “Boot” (602B). If the Recovery Start function is selected at any time other than when the BootState variable is set to “Boot” (for example the Recovery Start function is issued during time period 404 of FIG. 4), an error occurs. If such an error occurs, processing proceeds to step 624 of FIG. 6C, as indicated by arrow 602C. Otherwise, processing continues to step 603 where the BootState variable is set to “RecoveryStart”.

Recall that the Recovery Start function is issued to mark time 402 of FIG. 4. At this time, SCS 204 may discard the acquire queue 224, since it will now be the responsibility of the legacy OS 200 to recover any memory that was allocated on the legacy OS' behalf during this boot session (604). The address of the RBA for the current boot session data may be recorded (605). For example, the SCS 204 may record this address in a predetermined memory location so that it is available to be stored in the session data pointer field of the RBA for the next boot session. Additionally, the address of the RBA for the previous boot session data may be stored in the RBA of the current boot session data (606). This creates the linked list that is described in reference to FIG. 3. Processing may then return to block 600A as the booting of the first OS continues.

Returning to decision step 602, if the request is not a Recovery Start request, processing continues to FIG. 6B, as indicated by arrow 602A. There, decision step 607 is executed to determine if the received request is a Recovery Complete request. Recall that this type of request occurs when the IPC instruction is executed with the Recovery Complete function selected.

If a Recovery Complete request was received, it is next determined whether the BootState variable is set to “RecoveryStart” (607A). If the Recovery Complete function is selected at any time other than when the BootState variable is set to “RecoveryStart” (as may occur, for example, if the Recovery Complete function is erroneously issued during time period 400 of FIG. 4), an error occurs. If such an error occurs, processing proceeds to step 624 of FIG. 6C, as indicated by arrow 607B. Otherwise, if an error does not occur in step 607A, processing continues to step 608. There, the BootState variable is set to “RecoveryComplete”.

The setting of the BootState variable to “RecoveryComplete” corresponds to recovery complete time 406 of FIG. 4. At this time, the discard queue is processed and discarded (608). Processing of the discard queue involves making a request to a second OS, which in one embodiment is Linux, to release an area of memory associated with each entry on the discard queue. A request is then made to the second OS to discard the memory allocated for the discard queue itself. This allows all releasing of memory during time period 404 to occur in a deferred manner, as discussed above. When this processing is complete, execution returns to block 600A of FIG. 6A, as indicated by arrow 613.

Returning to decision step 607, if the request is not a Recovery Complete request, processing continues to step 609, where it is determined whether the request is an Acquire request. If so, a request is being made to acquire memory. In response, SCS 204 makes a request to the second OS to allocate an area of memory (610). Next, it is determined whether SCS must track the allocation of this memory. In particular, if the BootState variable is set to “Boot”, indicating that execution is occurring within time period 400 of FIG. 4 (611), an entry is made on the acquire queue to record the allocation of this memory (612). Processing then returns to block 600A of FIG. 6A, as indicated by arrow 613. If the BootState variable is not set to “Boot”, processing may merely return to block 600A of FIG. 6A without making a record of the memory allocation, since the first OS is at a point in the boot process where it is responsible for retaining this record on its own behalf.

In decision step 609, if the request is not an Acquire request, execution proceeds to decision step 614. There, if the request is a Release request, a request is made to the second OS to release a specified area of memory (615), and processing returns to block 600A of FIG. 6A, as represented by arrow 616. A release request may be used to release memory substantially immediately without deferred processing. This may be done to release memory that was allocated during the current boot session, and which is no longer needed.

If the request is not a release request, execution continues to step 618 of FIG. 6C, as indicated by arrow 619. In step 618, if the request is a deferred release request, as is issued by executing the IPC instruction with the Release Function selected and the Deferred Flag activated, it is determined whether the BootState variable is set to “RecoveryStart” (620). If so, the area of memory to be released, as indicated by the release request, is added to the discard queue (622). Processing then returns to book 600A of FIG. 6A, as indicated by arrow 623.

Returning to decision step 620, if a deferred Release request was received and the BootState variable is not set to “RecoveryStart”, an error occurred such that execution continues to error recovery block 624. This error occurred because the deferred Release request should only be issued during time period 404 of FIG. 4. The error recovery procedures are discussed further below.

Returning to step 618, if the request is not a deferred Release request, execution continues to step 626 where it is determined whether the request is a Recover request. If so, execution proceeds to step 628, where it is determined whether the BootState variable is set to “RecoveryStart”. If it is, the first OS is provided with a pointer to a recovered memory area containing data from a previous boot session (630). This memory area may be used to perform a state save operation, as discussed above. Then execution returns to block 600A of FIG. 6A, as represented by arrow 623.

If, in step 628, the BootState variable is not set to “RecoveryStart”, a Recover request should not have been issued. Therefore, an error occurred, and execution continues to block 624, where error processing will occur in a manner to be described below.

Returning to decision step 626, if the request is not a Recover request, processing continues to step 632, where it is determined whether the request is a Retrieve request. If so, and if the BootState variable is not set to “RecoveryComplete” (634), processing proceeds to step 636. There, a newly-allocated memory area is obtained and a copy operation is performed to transfer data into this memory area. A pointer to this memory area is then provided to the first OS. Processing may then return to block 600A of FIG. 6A, as indicated by arrow 623.

In step 634, if the Retrieve function was received but the BootState variable is set to “RecoveryComplete”, an error occurred. This is so because a Retrieve request is only to be issued before the recovery complete time 406 of FIG. 4 or an error occurred. If such an error occurred, processing proceeds to block 624 for error recovery processing.

Returning to step 632, if the request is not a Retrieve request, one of the other types of instructions listed in Table 2 may have been received. Such functions include the Set/Clear Attribute, Initialize, and Pin functions. If such requests are received (633), processing for the request is performed (635) and execution returns to block 600A of FIG. 6A. Otherwise, if in step 633 the received request does not include a legal function, error processing is initiated (624).

The type of error processing that is performed will depend on the implementation and/or the type of error that occurred. In one embodiment, the processing merely involves rejecting the request, which was issued by the first OS at an inappropriate time during the boot process. Other actions may be taken in addition, if desired, such as reporting the error. After this type of error processing completes, execution may return to the main request receiving loop at block 600A of FIG. 6A, as indicated by arrow 623.

In some cases, error processing 624 may determine that a received error is of a critical nature. In this case, processing occurs according to FIG. 6D as follows.

FIG. 6D is a flow diagram that illustrates the method that is executed if a critical error occurs any time during the booting of the first operating system, as illustrated by FIGS. 6A-6C (650). In this case, it is determined whether the BootState variable is set to “Boot” (652). This indicates processing is occurring within time period 400 of FIG. 4. If so, execution continues to step 656 where, for each entry on the acquire queue 224, a request is made to the second OS to release the memory associated with the entry. A request is then made to the second OS to discard the memory allocated to store the acquire queue itself. A new boot may then be initiated (654).

FIG. 6E is a flow diagram of a method for booting the legacy OS in accordance with embodiments of the current invention. The legacy OS is responsible for controlling the memory recovery process, but both the legacy OS and system control services 204 need to be synchronized. Many of the steps of FIG. 6E show how system control services 204 processes the IPC memory recovery functions.

At the start of a boot, as shown by step 670, system control services 204 increments the boot sequence identifier, stores the identifier, and starts the boot. The boot sequence number is input in the acquire and retrieve functions. It is passed to indicate the current boot's sequence number. Legacy OS will acquire memory during this session using this number.

Once the booting of the Exec is initiated at step 671, system control services 204 begins receiving the IPC instruction memory management request packets at step 672. The memory management functions are decoded and processed in steps 673-690. During the boot, Legacy OS does recover, dump, and discard memory from previous sessions but is also acquires memory for the current session.

If the function is “Acquire” (step 673), system control services 204 allocates an area of memory and at step 674 saves the memory allocation information associated with that memory area. In the example embodiment, the memory allocation information is saved in an entry on an allocation list, which is illustrated in FIG. 6F. The memory allocation information, along with the associated memory areas, are expected to be preserved across boots of the legacy OS since the legacy OS runs on the commodity OS, and the commodity OS is not expected to be rebooted with each reboot of the legacy OS. In addition, the system control services 204 maintains the allocation list across boots of the legacy OS.

If the function is “Release” (step 675), the kernel of the commodity OS is called to release the memory at step 676. The system control services 204 also removes the memory allocation information from the allocation list.

If the function is “Retrieve” (step 677), system control services 204 allocates an area of memory and at step 678 saves the memory allocation information associated with that memory area in an entry in the allocation list. Additionally the data associated with the source pointer is copied to the newly allocated memory area.

If the function is “Get Allocation” (decision step 679), at step 680 system control services 204 returns the allocation information associated with the specified area of memory. The allocation information is obtained from the allocation list.

If the function is “Update Allocation” (decision step 681), at step 682 system control services 204 updates one or more fields of the allocation information in the proper entry in the allocation list, depending on the Update Selector.

If the function is “Reset Retrieval Point” (decision step 683), at step 684 system control services 204 resets the internal retrieval point to the beginning of the allocation list.

If the function is “Get Next Allocation” (step 685), at decision step 686 system control services 204 determines whether there are any more allocations in the list of allocations. If so, at step 687 system control services 204 returns the memory allocation information associated with the current retrieval point. If there are no more allocations the retrieval point will be null, and system control services 204 returns the “End of Allocation” status at step 688. Once the function is completed the retrieval point will point to the next available memory allocation or be null.

If the function is any of various miscellaneous functions (decision step 689), which are beyond the scope of this invention, at step 690 system control services 204 executes the proper function. Otherwise, the “Invalid Function” status is returned in the memory management packet at step 691.

FIG. 6F illustrates an allocation list 692 that is used in managing memory allocations according to an embodiment of the invention. The example list includes allocation entries 693, 694, and 695. An entry is added and linked in the list using the next pointer for each memory allocation. Thus, there is an allocation entry associated with each area of memory that is allocated to the legacy OS. The fields in the entry correspond to and contain the values of the fields described above for the memory management packet for the Acquire function. Selected ones of the memory management functions as described above operate on the allocation list 692.

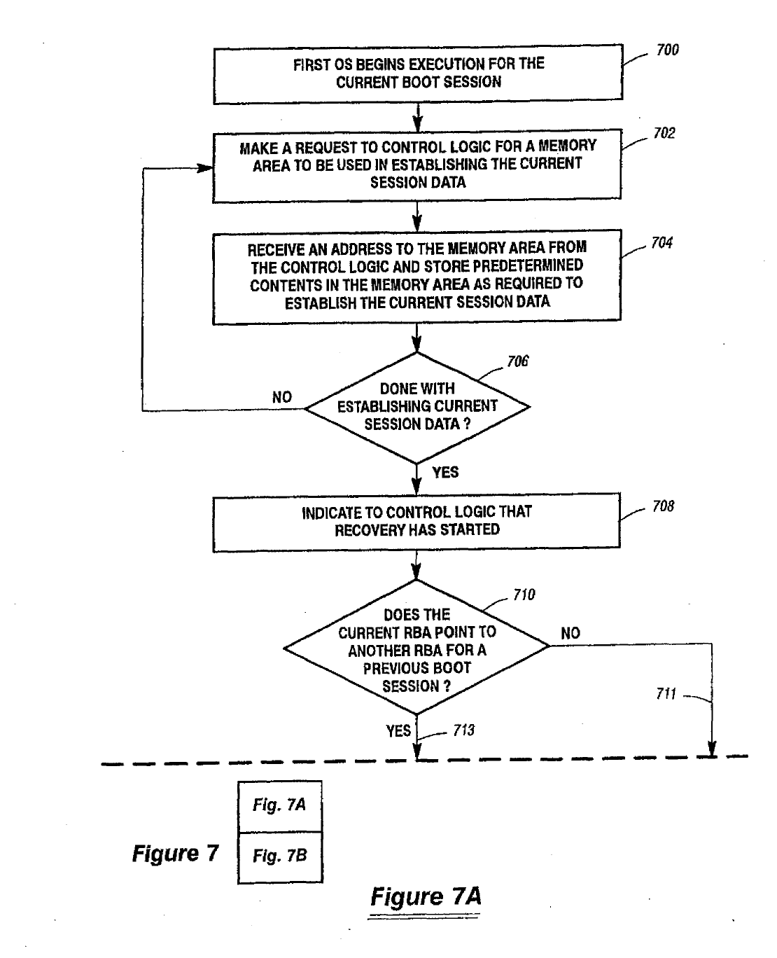

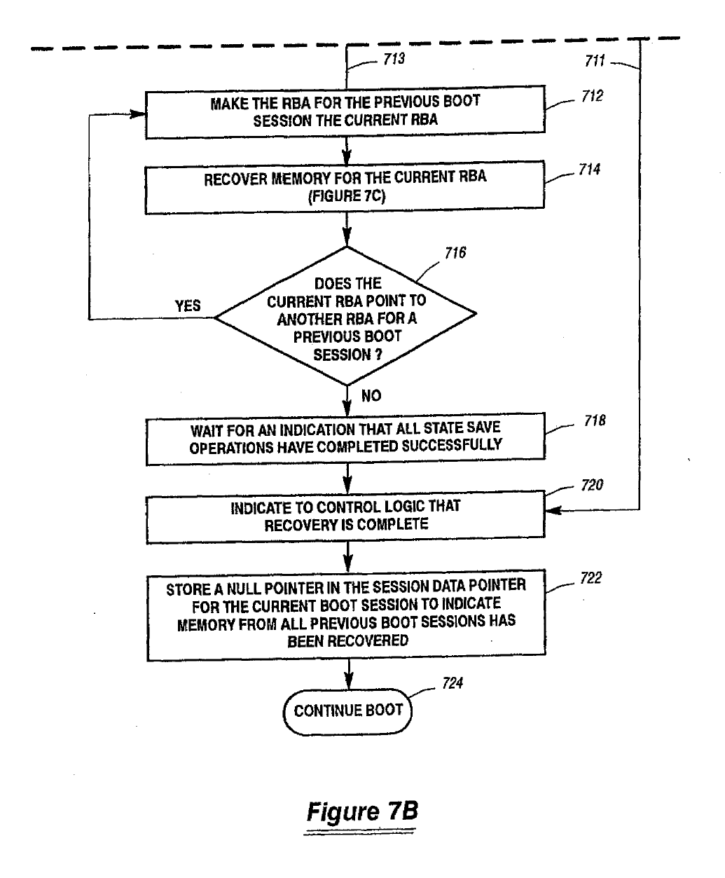

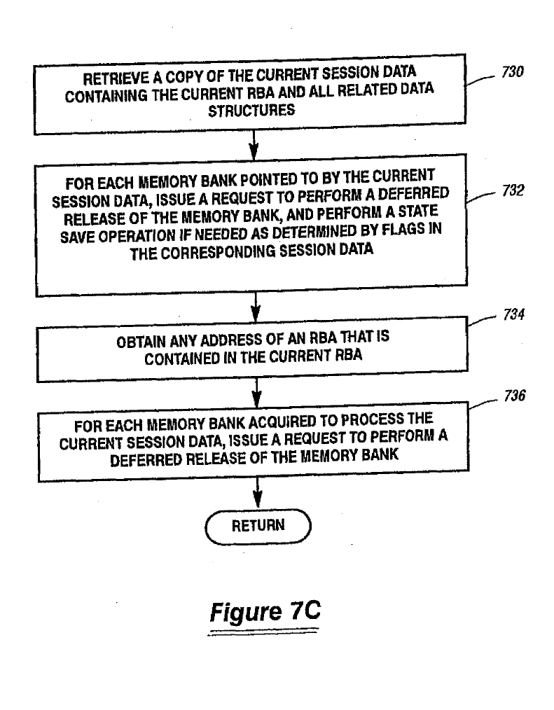

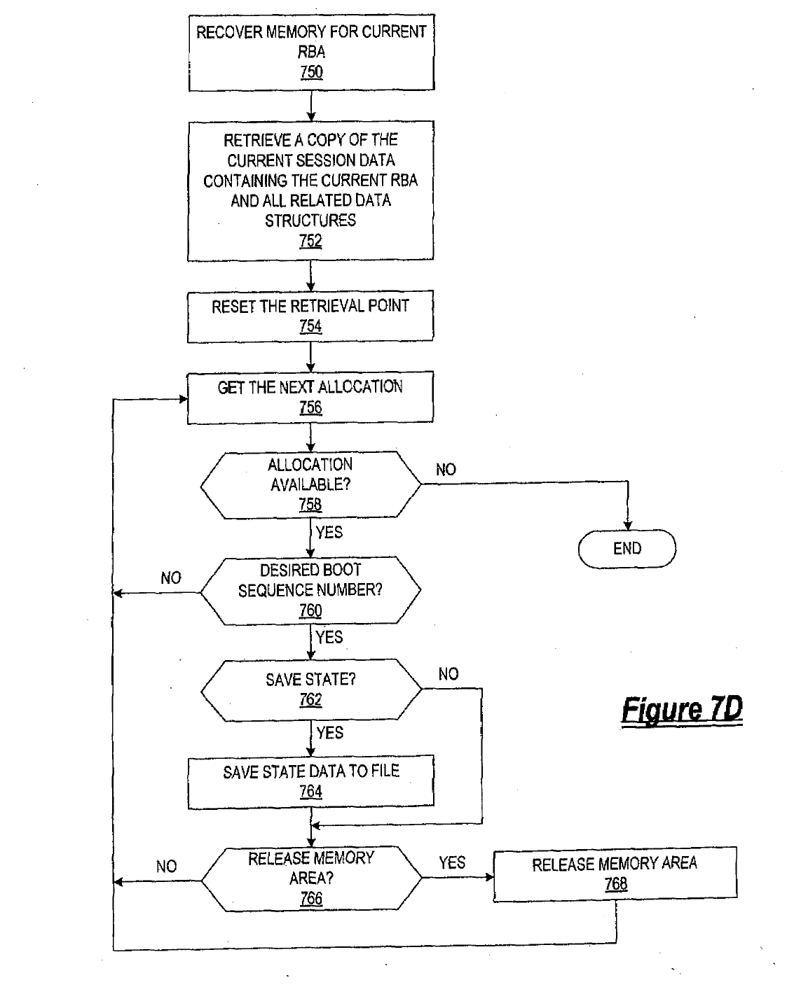

FIGS. 7A and 7B, when arranged as shown in FIG. 7, are a flow diagram of another process according to the alternative approach for handling data recover while booting the legacy OS. The example process is executed by legacy OS 200 executing on a commodity platform such as is shown in FIG. 2. The first OS, which in the current embodiment is the legacy OS 200, begins execution for a current boot session (700). This OS makes a request to system control logic 203 for a memory area that is to be used to establish the current session data for the current boot session (702). The address for the memory area is received from the control logic. In a manner largely beyond the scope of this invention, predetermined data structures are created and initialized within this memory area as required to establish the session data for the current execution environment (704).

Next, if the current session data has been established (706), an indication is provided to the system control logic 203 that recovery is started (708). In one embodiment, this involves executing an IPC instruction with the Recovery Start function selected. It is then determined whether the current Recovery Bank Area (RBA) included within the session data for the current boot session points to another RBA for a previous boot session (710). If not, execution continues to step 720 of FIG. 7B as shown by arrow 711. There, an indication is provided that recovery is complete, as may be accomplished by executing the IPC instruction with the Recovery Complete function selected. A null pointer may now be stored within the session data pointer of the current boot session to indicate memory allocated to all previous boot sessions has been recovered (722). Then the boot process may be continued in a manner largely beyond the scope of the current invention (724). Additional processing that is performed after this time involves tasks such as setting up files that will be utilized by legacy OS 200 to support the execution environment for application programs 208, for instance. When this processing is completed, legacy OS 200 is ready to begin accepting requests.

Returning to step 710 of FIG. 7A, if the current RBA points to another RBA for a previous boot session, processing continues to step 712 of FIG. 7B, as indicated by arrow 713. There, the RBA for the previous boot session is made the current RBA. The memory in the current RBA is then recovered according to the process of FIG. 7C (714). It is then determined whether the current RBA points to another RBA for a previous boot session (716). If so, processing returns to step 712 so that steps 712 and 714 may be repeated.

If, in step 716, the current RBA does not point to another RBA, the current RBA is the last RBA in the linked list. Therefore, processing waits for an indication that all state save operations have completed successfully. That is, all memory banks that were represented by an entry on state save queue 226 must have been stored successfully to retentive storage on mass storage devices 248 (718). After this is completed, an indication may be provided that recovery is complete (720). In one embodiment, this occurs by executing the IPC instruction with the Recovery Complete function selected. A null pointer may now be stored within the session data pointer field 307 of the session data for the current boot session (722). Then booting may continue in a manner largely beyond the scope of the current invention (724).

FIG. 7C is a flow diagram that illustrates processing performed to recover the memory associated with an RBA, in accordance with the alternative approach, as referenced in regards to step 714 of FIG. 7B. A copy of the session data for the current RBA is retrieved (730). For each memory bank pointed to by the session data that was most recently retrieved, a request is issued to perform a deferred release of the memory bank, with a state save operation being requested as needed (732). In one embodiment, the banks for which a state save is to be performed is indicated by flags maintained within the session data for the current session.

Next, an address for a next most recent session's RBA, if any, is retrieved from the current RBA (734). Any memory bank that was newly acquired to process the current RBA may then be released (736). In one embodiment, this will include the memory banks acquired to store the retrieved copy of the session data that is currently being processed. This may also include memory banks that were used to process recovered data that was no longer available in virtual address space. This release may be accomplished using the Release function with the Delayed flag set. Processing then returns to FIG. 7B, where execution proceeds to step 716.

The above description focuses on the recovery operation used to synchronize disparate operations so that memory leaks do not occur. Often times this process can be aided by determining why the boot process failed in the first place. By evaluating and addressing the fault situations, the need to recover and release memory may be minimized, thereby minimizing the opportunity for the creation of memory leaks.

Evaluation of faults is aided by the state save process described above. This involves storing the contents of memory banks to mass storage devices 248 based on the state of state save flags. Each memory bank may be associated with a respective flag that indicates whether that bank is to be saved during recovery processing. Other domain-specific flags may be used to determine whether all banks for a given domain are to be saved, as discussed above. Additionally, state save keys may be set to a predetermined state by an operator to indicate whether a state save should be performed. The state save keys take precedence over the state of the flags.

In the alternative approach to memory recovery, as described above, when the legacy OS halted unexpectedly, the core memory data of the legacy OS had to be reassembled by traversing the SYS-BDT→DLT→Sward→BCP-dbank→BCP chains (FIG. 3) and locating each memory allocation. That approach required a substantial amount of internal knowledge of the legacy OS and had the inherent limitation in that if the partition aborted before the legacy OS recovery was established, then all memory allocations from that boot session would be lost. For that reason the system control services 204 tracked memory allocations during the early stages of the boot process until the recovery mechanism became fully functional. With the embodiments of the current invention, the allocation information for each allocation in the allocation list allows the recovery process to retrieve and process the memory areas without having to traverse the various structures stored in those memory areas.

FIG. 7D is a flow diagram that illustrates processing performed to recover the data of a previous boot session according an embodiment of the invention. While booting the legacy OS, a Recoverable Bank Area (RBA) is established, and its address is retained across subsequent boots in the “Session Data” area (FIG. 3). Within each RBA is the address of its prior RBA; thus, a chain of RBA entries is maintained. This permits the legacy OS to traverse back through the environments for previous boot sessions and collect state information from those sessions.

The specific process steps of FIG. 7 show recovery, commencing with step 750, of memory for the RBA as currently referenced by a pointer (“current RBA). At step 752, the information of the current RBA is retrieved using the Retrieve function, and that information is used to locate a number of Exec data structures and the boot sequence number associated with the boot session associated with the current RBA.

The memory management Reset Retrieval Point function is initiated at step 754 to indicate to the system control services 204 to reset the retrieval point to the beginning of the allocation list. The legacy OS at step 756 then invokes the Get Next Allocation function to retrieve the next memory allocation information from the allocation list. If no more allocation entries are available as indicated by the no allocation information having been returned from the Get Next Allocation function (decision step 758) the memory recovery is complete for the current RBA.

If allocation information was returned, the process compares the boot sequence number from the allocation information to the RBA boot sequence number at step 760. If the sequence numbers match, the data in the memory area will be processed; otherwise the next allocation will be examined as shown by decision step 760. If the memory allocation information specifies that the state data in the memory should be saved (decision step 762), that data is stored in retentive storage at step 764. If the state_save_flags specify that the memory are is to be released (decision step 766), the memory area is released by invoking the memory management Release function at step 768, and the process returns to step 756 to get the allocation information from the next allocation entry. Otherwise, the memory area is not released.

While not shown, it will be appreciated that the RBA chain is traversed, and the memory recovery process is repeated for each RBA. If a state save is to be performed for a memory area and more than one state-save is detected in the partition data bank (PDB), the state save is considered a “Full” save, and both state-saves and their associated environmental information are written to the Exec dump. Memory recovery processing may be bypassed if there is no memory area available to recover.

### IV. State Save Analysis

If a state save operation occurs during a re-boot operation, the contents of the saved memory banks that are created by legacy OS 200 are stored as state save files 230 (FIG. 2) on mass storage devices 248. In the rare case wherein a boot occurred during time period 400 of FIG. 4, one or more state save files 250 may also be stored on mass storage devices 108. These state save files 250 are created by SCS 204 as opposed to being creating by legacy OS 200.

In addition to state save files 230, which are created by legacy OS 200, and state save files 250, which are created by SCS 204, a third type of state save file may be created within the system of FIG. 2 in the manner described above. These are shown as commodity OS state save files 252. These files are created when a critical fault occurs on the data processing system, thereby causing commodity OS 110 to fail. In this case, commodity OS will save its state to state save files 252 on mass storage devices 108 before the commodity OS stops execution. Memory included in these state save files may be recovered by legacy OS using the Recover function. In such cases, some of the data initially included within state save files 252 that described one or more execution states of legacy OS 200 from one or more previous boot sessions is incorporated into state save files 230.

State save files 230 and 250 contains data that primarily describes the legacy OS' execution state. These files may be transferred to analysis system 234, which is a system that is adapted for analyzing legacy OS' execution state. In contrast, state save files 252 are not dedicated to storing information on legacy OS' execution state, but instead contain data describing the state of the entire system at the time a fault occurred. These state save files 252 therefore contain a large amount of data that is beyond the scope of the current invention. For this reason, most of the data contained within state save files 252 is not generally transferred to analysis system 234 for analysis, but is reviewed in some other manner. Only selected portions of state save files 252 that are recovered via the Recover function and thereafter saved to state save files 230 will be analyzed by analysis system 234.

Analysis system 234 may be located at a same, or a different, site relative to the original data processing system 201. In one implementation, the state save files are transferred to analysis system via a communication link 232, which may be a “wired” or a wireless connection. The files may be transferred using a Transmission Control Protocol/Internet Protocol (TCP/IP) protocol, a File Transfer Protocol (FTP), or any other type of suitable communication protocol.

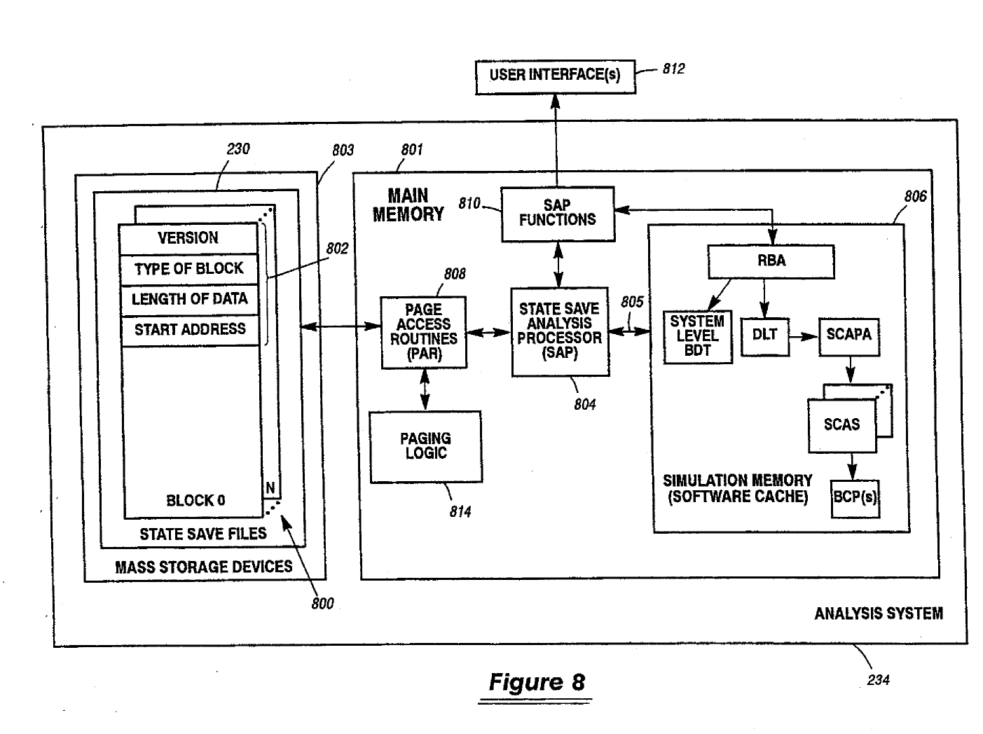

Once the files are resident on the analysis system 234, they are reconstructed and analyzed using a state save tool as discussed in reference to FIG. 8.

FIG. 8 is a block diagram of an analysis system 234 used to analyze state save files. This analysis system is a data processing system that may be similar to that shown in FIG. 2. That is, it may include a main memory 801, one or more caches, and one or more instruction processors (not shown). The main memory may be coupled to one or more mass storage devices 803.

State save files 230 may be transferred from the system from which they were capture (i.e., “target system”) to storage devices of analysis system 234. In the embodiment shown in FIG. 8, these files are transferred to mass storage devices 803. In another embodiment, the files could be transferred to main memory 801 of the analysis system 234 if the memory of the analysis system were large enough.

According to one implementation, the state save files include multiple blocks, shown as blocks 0-N 800 of FIG. 8. Each block may include the contents of one or more memory banks saved from the target system. In one embodiment, these blocks are not necessarily stored in any order that corresponds to the virtual addresses represented by the blocks. For instance, assume a first block contains data for virtual addresses 0-1000, and an Nth block contains data for virtual addresses 1001-2000. These blocks need not be stored contiguously in state save files 230. Moreover, the first block need not be stored before the Nth block. This lack of storage restrictions allows the state save files to be created much more quickly by legacy OS 200. However, this provides challenges when retrieving the data, as will be described below.

Each block includes a header 802 with various fields describing the contents of the block. One field may provide a version, which indicates the version of the block format. If changes to the state save data require the addition or removal of fields within some of the blocks, the analysis system 234 may use the version field to interpret the various block formats.

A type field may also be provided. For instance, the type may indicate that the block stores a memory bank that was allocated to legacy OS 200 for use in storing its execution environment. As another example, the block may contain a code bank that stored instructions for one of APs 208. Alternatively, the block may contain a data bank used by one of APs 208.

Header 802 may further contain fields indicating the length of data stored within the block, as well as the starting address of the block. In the current embodiment, this starting address is the virtual address at which the block resided in virtual address space on the target system.

A State Save Analysis Processor (SAP) 804 is loaded into the main memory 801 of, and executes on, the analysis system. In one embodiment, the SAP processor is a software application. However, in a different embodiment, part or all of the SAP may be implemented in hardware. SAP 804 controls retrieval of the blocks of the state save files 230. The SAP also controls the reconstruction of the session data and other memory banks for the one or more boot sessions that are described by the retrieved state save blocks. This reconstructed data is retained within simulation memory 806, which is allocated to SAP 804 by analysis systems 234. In one embodiment, simulation memory 806 is a software cache, as will be discussed further below.

The reconstruction of the session data within simulation memory 806 occurs as follows according to one implementation of the invention. SAP functions 810 initiate retrieval of a predetermined block from the state save files 230. This may be a block from a predetermined location within the state save files 230 (e.g., the first block of a first file). Alternatively, this block may be that having a predetermined virtual address stored in the “start address” field of its block header 802. In either case, the execution of SAP functions 810 cause SAP 804 to communicate to the page access routines (PARs) 808 that this block is to be retrieved from the state save files 230.

The PARs 808 are routines that are responsible for retrieving blocks from the state save files. Generally, SAP 804 will pass PARs 808 the virtual address for the block that is to be retrieved. This virtual address is the address stored within the “start address” field of a block header. PARs 808 will first determine whether this block was previously retrieved from the state save files 230. This is accomplished by making a call to paging logic 814. If the block was previously retrieved, paging logic 814 passes the block's location within state save files 230 so that this block may be retrieved directly without the need to perform a search. If, however, the block was not previously retrieved, PARs 808 must perform a linear search of all of the blocks in the state save files 230 to locate the block having a header containing the specified starting address in its “start address” field.

Once the specified block is retrieved, this block is transferred into simulation memory 806. If this was the first time this block was retrieved, PARs 808 provides to paging logic 814 the location within state save files at which the block was retrieved. Paging logic records this location for use later if the block is transferred out of simulation memory because simulation memory becomes full. This is discussed further below.

After a block that is retrieved from the state save files 230 is stored within simulation memory 806, it may be used by SAP 804 to retrieve additional blocks from state save files. This is possible because SAP functions “understand” the format of the session data construct (one embodiment of which is shown in FIG. 3). SAP functions are therefore able to retrieve pointers from the appropriate fields within this session data. For example, after a predetermined block containing an RBA has been stored within simulation memory 806, SAP functions are able to retrieve addresses pointing to the system-level BDT 304, the DLT 306, and any other pertinent data structures.

Once a SAP function has retrieved an address pointing to another construct that is to be retrieved, SAP passes this address to PARs 808 for retrieval in the manner described above. The retrieved block is passed to SAP to be stored in simulation memory 806. In this manner, some or all of the session data may be reconstructed within simulation memory 806.

After at least a portion of the session data has been reconstructed, other memory buffers (e.g. memory banks 311 and/or memory buffers 210) may likewise be retrieved using pointers from the session data. The content of these buffers (code and/or data) may be recovered so that all data constructs of interest are eventually recreated within simulation memory 806.

As may be appreciated, the reconstructed data is no more than a very large memory area containing “ones” and “zeros”. A system analyst viewing data in this format would have a difficult time interpreting this information. Therefore, SAP functions 810 interpret this data and place it into a much more “user-friendly” format that may be displayed via user interface(s) 812, which may include a printer and/or a display screen.

SAP functions 810 “understand” the format of session data. SAP functions 810 are therefore able to access the various constructs contained within simulation memory 806 and provide those constructs to a user in a table or other similar format that includes ASCII headers and text that explains what a user is viewing. The data itself may be provided in a selected format, such as binary, hexadecimal, octal, and so on.

As an example, a user of user interface(s) 812 may indicate that he or she wishes to view the RBA of a particular boot session. In response, SAP functions 810 retrieve the contents of the RBA for the specified boot session from simulation memory 806 and provide those contents to the user in a user-friendly format. As discussed above, the format may include ASCII labels for each of the fields followed by the data in a specified format. As an example, one display may include the following information, with data in hexadecimal format:
Recovery Bank Area: Session 1
System Level BDT for Boot Session 1: 400000000H
Domain Lookup Table: 700000000H
Session Data Pointer for Boot Session 0: 39FF80000H
   An RBA will contain large amounts of data, some or all of which is labeled with a corresponding label in the manner exemplified above.

In one embodiment, the user interface(s) include a Graphical User Interface (GUI) that allows a user to easily traverse between the various constructs that have been reconstructed within simulation memory. For instance, the label “System Level BDT for Boot Session 1” appearing in the exemplary display set forth above may be link. When a user selects this link with his cursor or another input device, the SAP functions 810 cause the addressed memory banks to be located and retrieved from simulation memory 806, or if necessary, state save files 230. The data contained within this structure may then be displayed for the user and the process repeated. “Back” and “Forward” functions available on many GUI interfaces may be provided to return to previously-viewed screens. These mechanisms allow the user to quickly traverse between the interconnected structures of the session data so that the operating environment that existed during a particular boot session may be viewed and readily comprehended.

Using the session data pointer contained within a RBA, a user may further traverse to the session data for one or more previous boot sessions. This may help a user determine whether a pattern exists, such as a failure that is always occurring when a particular type of operation is underway.

The user interface(s) 812 provide a mechanism whereby a user may request the contents of any virtual address represented by the state save files 230. If the requested contents are not currently loaded into simulation memory 806, SAP 804 operates in conjunction with PARs 808 to process the request so that the requested block(s) are retrieved from state save files 230 and loaded. The contents may then be provided to the user.

In most cases, when a user provides a request to view the contents of an address, the request contains a virtual address. This corresponds to the virtual addresses contained within headers 802. However, a user may optionally specify that the provided address is a real address. In this case, SAP functions 810 or SAP 804 converts this physical address into a virtual address using the virtual-to-physical memory mapping that had been in use at the time the session data was created. This memory map is contained within the session data reflected by state save files 230 and simulation memory 806, and is therefore available to SAP functions for use in performing this physical-to-virtual address conversion process.

The foregoing describes a system wherein at least some of the blocks included within state save files are reconstructed within simulation memory 806, and then the user may begin viewing the contents of requested ones of these blocks. For example, generally at least the memory map contained within the session data is reconstructed in simulation memory 806 before SAP functions 810 begins receiving requests from users. In another embodiment, a user of user interface(s) 812 is allowed to specify via those interfaces which memory areas are to be viewed. For instance, a menu on a GUI interface may allow a user to indicate that he or she wants to view the contents of the system level BDT and the SCAPA for a given session. Upon receipt of this request, SAP functions 810, via SAP 804, will only initiate, via PARs 808, retrieval of those areas that are needed to obtain the data requested by the user. This allows the user to begin viewing the contents of data with a minimal amount of delay.

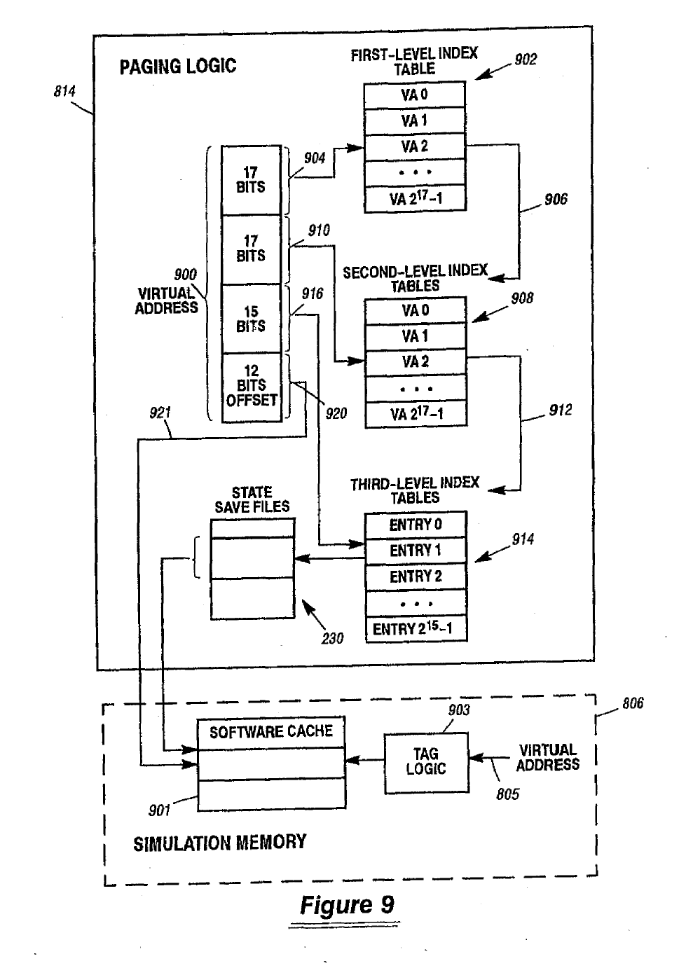

One of the challenges associated with the use of a simulation memory 806 as shown in FIG. 8 is that the size of this memory is much smaller than the size of the virtual memory space of the target system. For instance, in one embodiment, the virtual address space of the target system is described using a 61-bit C pointer, and therefore may be 2⁶¹ words in length. According to one embodiment, this challenge is addressed using paging logic 814 and a software cache. This is described further in reference to FIG. 9.

FIG. 9 is a block diagram of the paging logic 814 according to one embodiment of the invention. According to this embodiment, SAP 804 provides a virtual address on interface 805 to simulation memory 806 (shown dashed in FIG. 9), which is implemented as a software cache 901 and corresponding tag logic 903. In one embodiment, the address provided to simulation memory 806 is a 61-bit C pointer.

Software cache 901 is divided into multiple cache blocks, each of which may store a predetermined number of the blocks from the state save files 230. Tag logic 903 records the start addresses for the state save file blocks that are stored within each of the cache blocks at a given time.

When an address is provided to simulation memory 806, tag logic 903 applies a hash function to the address. The results of this hash function selects one of the blocks of the software cache. An entry within tag logic 903 that corresponds to the selected cache block is referenced to determine whether the requested state save block is already resident within the cache block. If so, the contents of the state save block may be read from the software cache and presented to the user. Otherwise, the state save block must be retrieved from state save files 230.

As discussed above, the blocks of a state save file 230 need not be arranged in any order that corresponds to the virtual addresses represented by the blocks. This arrangement is selected because it allows legacy OS 200 to save data more quickly and efficiently when a state save file 230 is created. This type of mechanism is in contrast to prior art analysis systems, which store saved data in a manner that does correspond to addresses. Such prior art systems increase the amount of time required to create the files.

Because the current system does not store the data blocks in any order that may be determined by the virtual addresses, a virtual address cannot be used to determine which block of the state save files 230 contains the addressed data. Therefore, when a virtual address is being used for the first time to retrieve data from state save files 230, the only way to initially locate the block of data corresponding to this address is to perform a linear search of all blocks in the state save file. Once the requested block is located in this manner, the location of this block is retained in paging tables. In FIG. 9 these paging tables are shown as the first-level, second-level, and third-level index tables 902, 908, and 914, respectively. These tables are used as follows.

When a block is to be retrieved, the tables contained in paging logic 814 are referenced to determine whether the requested state save block was previously retrieved from the state save files 230. To do this, the virtual address is divided into four portions, as shown in block 900. A first-level index table 902 is referenced by a first portion of the virtual address. In one implementation, this first-level index table includes 2¹⁷ entries, one of which is selected by the 17-bit portion 904 of the virtual address.

Each entry in the first-level index table stores a pointer. Each pointer points to one of the second-level index tables 908. Up to 2¹⁷ different second-level index tables may be created according to this embodiment.

Next, address portion 910 of the virtual address is used to select an entry from the second-level index table that was chosen via pointer 906. As may be appreciated, because address portion 910 includes 17 bits, each one of the second-level index tables may include up to 2¹⁷ entries.

Each entry of each of the second-level index tables 908 stores a pointer. Each pointer points to one of the third-level index tables 914. Up to 2¹⁷ different third-level index tables may be created according to this embodiment.

Address portion 916 of the virtual address is used to select an entry from the third-level index table that is identified by pointer 912. This fifteen-bit field may select any one of up to 2¹⁵ entries. If the requested state save block has been retrieved from the state save file at least once during the current analysis session, the contents of this selected entry will be set to point to the location within state save files 230 that contains the requested block of state save data.

If the requested state save block has never been retrieved during this state save session, the located entry within the third-level index tables 914 will be set to some initialization value, such as “0”. In this case, paging logic 814 conducts a linear search of state save files 230 to locate the block that has, as its start address in the start address field of header 802, the virtual address represented by address portions 904, 910, and 916 of FIG. 9. The location of this block within the state save files is then recorded within the corresponding entry of the third-level index tables 914. This information is now available for use if that same state save block must be retrieved from state save files again in the future.

Next, the contents of the block are loaded into the block of the software cache 901 that was selected by the hashing function of tag logic 903, and the tag logic is updated to record that this block is now resident in cache. Finally SAP 804 adds the offset 920 to the block address to access the addressed data word within the block, as shown by arrow 921. In one embodiment, this offset is used to access a selected 36-bit data word, which is the word size utilized by the legacy platform to which legacy OS 200 is native. This accessed data is used or displayed by the one of SAP functions 810 that initiated the request.

As discussed above, if the requested state save block has been located within state save files during this analysis session, the located entry within third-level index tables 914 will already store the location of the state save block. This allows the requested contents to be retrieved from state save files 230 without conducting a search. This information is then loaded into software cache 901 in the manner described above.

In some cases, when a virtual address is provided to tag logic 903 for use in retrieving contents of a state save block, that block is not resident in the software cache 901. Moreover, the cache block that corresponds to this state save information, as determined by the tag logic hashing function, is already full. In this case, one implementation of tag logic 903 uses an aging algorithm to determine which state save block will be aged from the selected cache block to make room for the newly-requested data. The requested data is retrieved from state save files 230 in one of the ways discussed above and stored in place of the state save data that was aged out of cache.

In the foregoing manner, the first-, second-, and third-level index tables are used to record the location of blocks of state save data within state save files 230. These tables may be created as follows. The first-level index table 902 may be created during initialization of SAP 804 and PAR 808. Second-level and third-level index tables 908 and 914 may be dynamically created as needed. For instance, assume that address portion 904 references an entry within first-level index table 902 that contains a null pointer. As a result, PAR 808 requests new memory banks for use in storing another second-level index table, as well as another third-level index table. These banks are allocated to the SAP 804 by analysis system 234.

Next, the bank address of the second-level index table is stored in the selected entry of the first-level index table. The entry in the second-level index table selected by address portion 910 is initialized to store the bank address of the newly-allocated third-level index table. After a search of the state save files 230, the entry in the third-level index table that is selected by address portion 916 is initialized to point to a location within the state save files. This location stores the state save block that has as its start address the virtual address determined by concatenation of address portions 904, 910, and 916.

The above-described analysis system is adapted for use with the type of target system shown in FIG. 2 that includes a legacy OS that operates primarily in virtual address space. The analysis system is adapted to use virtual, rather than physical, addresses to retrieve data from the state save files unlike other similar analysis tools that operate in physical address space. The analysis system is adapted to use those virtual addresses to reconstruct the operating environment within simulation memory on behalf of the user.

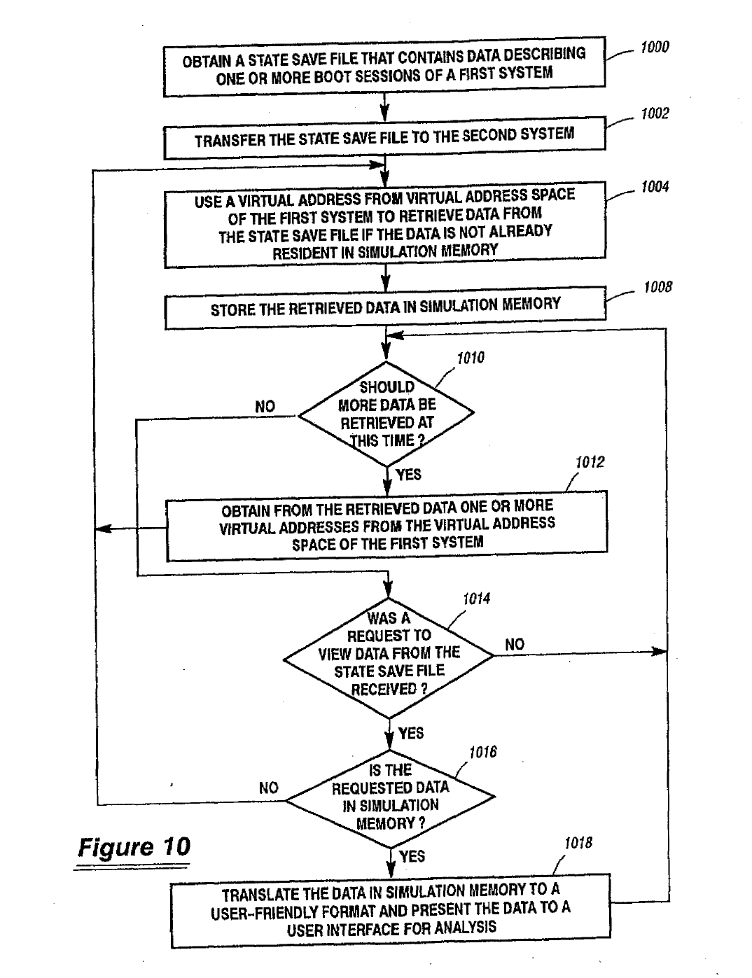

FIG. 10 is a flow diagram of a state save analysis process according to the current invention. The embodiment of FIG. 10 assumes that some state save data is reconstructed in simulation memory before the system begins receiving requests from a user and/or from SAP functions 810.

According to the method of FIG. 10, a state save file is obtained that contains data describing one or more boot sessions that occurred on a first system (1000). This state save file is transferred to a second system, which is analysis system 234 of the current invention (1002).

Next, a virtual address from the virtual address space of the first system is obtained. For instance, this may be a known virtual address at which an RBA will be located. Assuming that the data at this virtual address is not already resident in simulation memory of the analysis system, as will be the case immediately after the state save file has just been transferred to the analysis system, the virtual address is used to retrieve the requested data from the state save file (1004).

Assuming the data was not already resident in simulation memory and was therefore retrieved from the state save file, the retrieved data may then be stored in simulation memory (1008). If more data is to be retrieved at this time using a virtual address obtained from data already stored in simulation memory (1010), a virtual address may be retrieved from the data already stored within simulation memory (1012). For instance, addresses of the system level BDT 304 or DLT 306 may be obtained from the RBA that has now been stored in simulation memory 806. Processing then returns to step 1004, where the obtained virtual address is employed to retrieve data from the state save file if that data is not already resident in simulation memory.

Whether more data is to be retrieved in step 1010 may depend on implementation. For instance, the system may be configured to retrieve certain state save data such as the RBA and other memory map data from the execution environment. Then the user is allowed to begin issuing requests specifying the data he or she wants to view. In another configuration, more data (e.g., session data for one session) may be constructed in simulation memory before the system begins receiving requests from a user.

In step 1010, if it is unnecessary to retrieve more data at this time using the addresses contained in previously-retrieved data, processing proceeds to step 1014. There, it is determined whether a user request was received to view state save data. Such a request may be presented via user interfaces 812, for example. If a request is received, it is determined whether the requested data is already in simulation memory (1016). If so, the data is retrieved from simulation memory and is provided in a “user-friendly” format via one of the user interfaces (1018). This may involve providing a printout to a printer or other device so that a “hard” copy of the data is obtained. Alternatively, this may involve sending the data to a screen display, or providing the data in electronic format to another output device such as a disk burner or the like. Then processing continues to step 1010, where it is determined whether more data is to be retrieved at this time.

If, in step 1016, the data is not in simulation memory, processing proceeds to step 1004 where a virtual address from the request may be used to retrieve the requested data from the state save file. This retrieved data is stored within simulation memory, and when decision step 1014 is again encountered, the data will be available for retrieval from simulation memory.

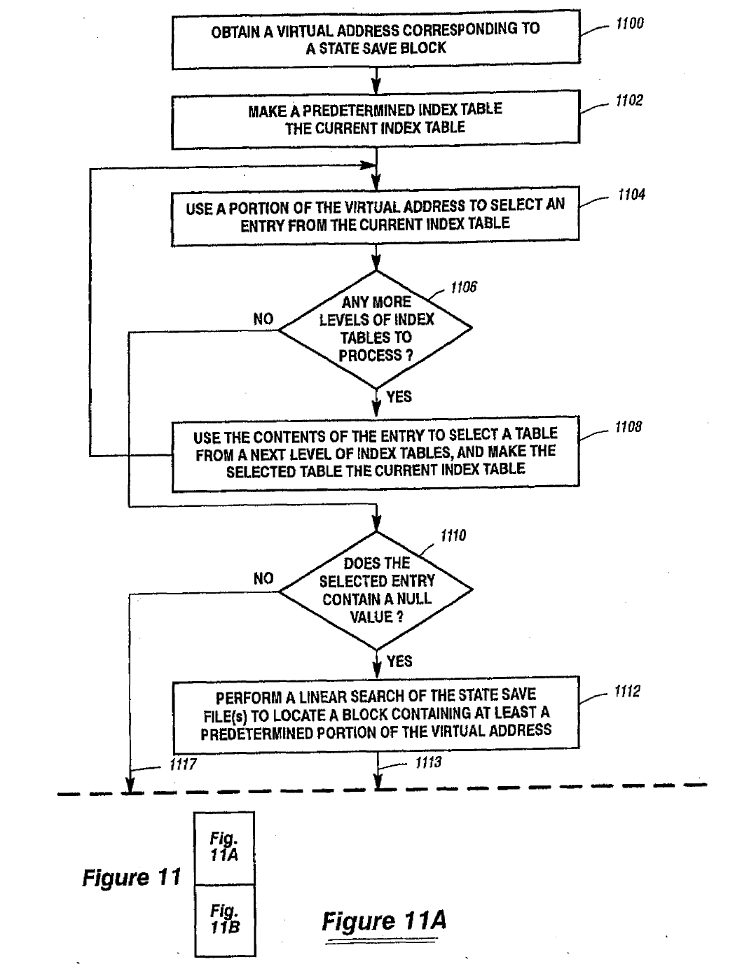

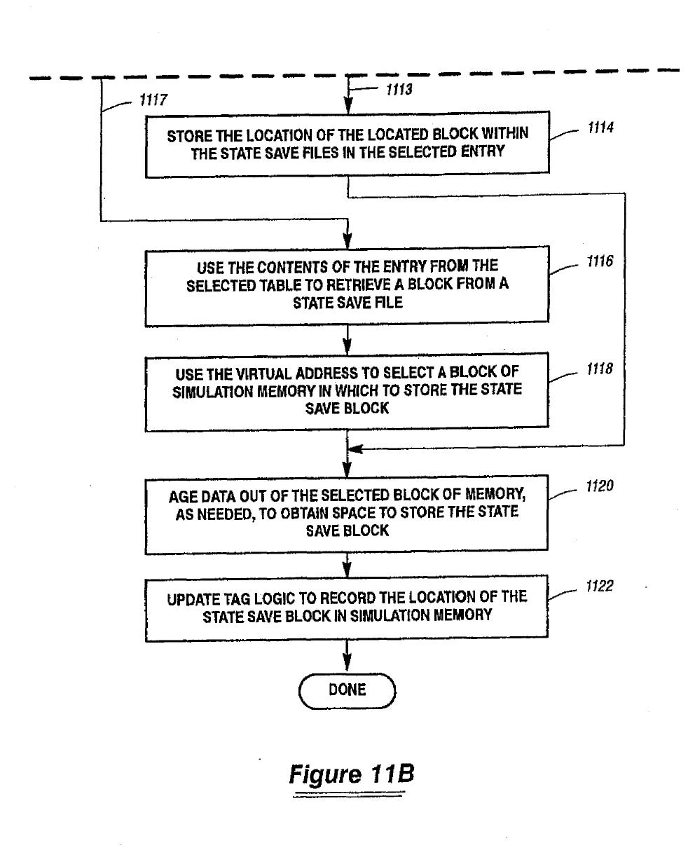

The method of FIG. 10 describes the overall process of retrieving state save data for presentation to a user. FIG. 10 does not describe the specific techniques used to record the location of data within the state save files and in simulation memory. This is illustrated further in reference to FIG. 11.

FIGS. 11A and 11B, when arranged as shown in FIG. 11, are a flow diagram illustrating a method of managing state save data as it is retrieved from the state save files and stored in simulation memory. First, a virtual address corresponding to a state save block is obtained (1100). This virtual address may be retrieved from state save data already stored in simulation memory, or from a user request.

Next, a predetermined index table is made the current index table for purposes of initiating a search (1102). In the embodiment of FIG. 9, the predetermined index table is the first-level index table 902. A portion of the virtual address is used to select an entry from the current index table (1104). If more levels of index tables remain to be processed (1106), the contents of the entry are then used to select a table from a next level of index tables (1108). Thus, for instance, the contents of a selected entry from the first-level index table are used to select an entry for the second-level index table. Processing then returns to step 1104 and the process is repeated. These steps may be repeated any number of times. That is, even though the embodiment of FIG. 9 illustrates only three levels of index tables, more may be employed if desired.

If, in step 1106 no more index table levels remain to be processed, execution continues with step 1110, where it is determined whether the selected entry contains a null value. If so, the virtual address being used to perform the search was not previously used to retrieve a block from state save files 230. Therefore, a linear search of the state save file(s) is performed to locate a block containing at least a predetermined portion of the virtual address (1112).

Processing continues to FIG. 11B, as indicated by arrow 1113. There, when the block is located, the location of the block within the state save files is stored in the selected entry (1114).

Returning to step 1110 of FIG. 11A, if the selected entry does not contain a null value, processing continues to step 1116 of FIG. 11B, as illustrated by arrow 1117. There, the contents of the entry from the selected table are employed to retrieve a block from a state save file.

In either of the cases described above, the virtual address is next used to select a block of simulation memory in which to store the state save block (1118). In one embodiment, simulation memory is implemented as a software cache, and a hash function is applied to the virtual address to select the block in simulation memory in which to store the state save block. Any hash function known in the art may be selected for this purpose.

Next, if needed, data is aged out of the selected block of simulation memory to obtain space to store the newly-acquired state save block (1120). The tag logic associated with the software cache is updated to record the location of the state save block in simulation memory (1122).

It will be understood that the above-described methods are exemplary only. In many cases, steps may be re-ordered or omitted entirely within the scope of the current invention. Steps may also be added in other embodiments.

The state save techniques described herein support the analysis of several types of state save files, including first state save files 230 that are created by a first OS, which in one embodiment is a legacy OS. The state save files further include second state save files 250 that are created by SCS 204 on behalf of the first OS. As discussed above, these second state save files are created if the system fails before the first OS has established its operating environment for a current boot session. The state save data available for analysis further includes portions of a third type of state save files 252. This third type of files is created by a second OS, which may be a commodity OS, and is recovered by the first OS for inclusion in state save files 230. Thus, analysis system 234 provides a tool that can utilize many forms of data to reconstruct an execution environment of a failed system.

As discussed above, the state save system and method support a mechanism that allows blocks of state save data to be stored in an order that is not based on the data's virtual addresses. This decreases the amount of time required to create the state save files. Paging tables are used to record the location of data within the state save files so that once a virtual address is retrieved once from the state save file, the same data may be efficiently retrieved again in the future should that data be aged from a cache of the analysis system, such as software cache 901. Virtual or physical addresses may then be employed to retrieve state save data from simulation memory 806. This is in contrast to prior art simulation environments that operate solely using physical addresses. Finally, the SAP functions 810 allow the data to be displayed in user-friendly formats so that an execution environment of one or more boot sessions may be efficiently analyzed.

Those skilled in the art will appreciate that various alternative computing arrangements, including one or more processors and a memory arrangement configured with program code, would be suitable for hosting the processes and data structures of the different embodiments of the present invention. In addition, the processes may be provided via a variety of computer-readable storage media or delivery channels such as magnetic or optical disks or tapes, electronic storage devices, or as application services over a network.

The present invention is thought to be applicable to a variety of software systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A processor-implemented method for recovering state data between boot sessions of an operating system, comprising:
executing a first operating system (OS) on an instruction processor of a data processing system, wherein the first OS includes instructions of a first instruction set that are native to the instruction processor;
emulating a second OS using an interface to the first OS on the data processing system, wherein the second OS includes instructions of a second instruction set that are not native to the instruction processor;
in response to each memory acquire request from the second OS to the interface, returning a memory area for use by the second OS and storing by the interface, allocation data associated with the memory area, including an address referencing the memory area and a boot sequence number, wherein the boot sequence number indicates a boot session of the second OS;
while booting the second OS to a current boot session, retrieving the stored allocation data from the interface for the second OS;
in response to the stored allocation data including a selected boot sequence number, storing data from the memory area referenced by the address in the allocation data in one or more files in retentive storage by the second OS.

2. The method of claim 1, further comprising releasing the memory area after the storing of data from the memory area.

3. The method of claim 1, wherein the allocation data further includes a state-save control code, the storing of data from the memory area is in response to a first value of the state-save control code, and in response to a second value of the state-save control code omitting the storing of data from the memory area.

4. The method of claim 1, wherein the allocation data further includes a control code, the method further comprising:
in response to a first value of the control code, releasing the memory area after the storing of data from the memory area; and
in response to a second value of the control code, omitting releasing of the memory area.

5. The method of claim 1, wherein the allocation data further includes a control code, the method further comprising:
wherein the storing of data from the memory area while booting the second OS is in response to a first value of the control code, and in response to the first value of the control code, releasing the memory area after the storing of data from the memory area;
in response to a second value of the control code storing the data from the memory area and omitting the releasing of the memory area;
in response to a third value of the control code, omitting the storing of data from the memory area and releasing the memory area; and
in response to a fourth value of the control code, omitting the storing of data from the memory area and omitting the releasing of the memory area.

6. The method of claim 1, further comprising:
in response to each memory acquire request from the second OS to the interface, storing by the interface, allocation data describing each acquire request in a respective entry in an allocation list;
wherein the retrieving the stored allocation data includes reading allocation data from the entries in the allocation list.

7. The method of claim 6, wherein the allocation data further includes a control code, and each entry in the allocation list has a respective control code value, the method further comprising conditioning the storing of data from the memory area in response to the value of the respective control code value.

8. The method of claim 7, further comprising conditioning release of the memory area referenced by an entry in response to the value of the respective control code value.

9. The method of claim 1, wherein the allocation data further includes a respective control code value for each memory acquire request, wherein the storing of data from a respective memory area as referenced by the allocation data is conditional in response to the value of the respective control code.

10. The method of claim 9, conditioning release of the memory area referenced by an entry in response to the value of the respective control code value.

11. A system for recovering state data between boot sessions of an operating system, comprising:
a data processing system including a first type instruction processor, wherein the data processing system executes a first operating system (OS) that includes instructions of a first instruction set that are native to the first type instruction processor;
an instruction processor (IP) emulator executing on the first OS, the IP emulator emulating execution of instructions of a second instruction set that are not native to the first type instruction processor, wherein the IP emulator executes a second OS that includes instructions of the second instruction set;
an interface coupled to the IP emulator and executing on the first OS, wherein the interface, responsive to each memory acquire request from the second OS to the interface, returns a memory area for use by the second OS and stores allocation data associated with the memory area, including an address referencing the memory area and a boot sequence number, wherein the boot sequence number indicates a boot session of the second OS;
wherein the second OS, while booting to a current boot session, retrieves the stored allocation data from the interface, and responsive to the stored allocation data including a selected boot sequence number, stores data from the memory area referenced by the address in the allocation data in one or more files in retentive storage.

12. The system of claim 11, wherein the second OS is further configured to release the memory area after the storing of data from the memory area.

13. The system of claim 11, wherein the allocation data further includes a state-save control code, and the storing of data from the memory area by the second OS is in response to a first value of the state-save control code, wherein the second OS is further configured to omit the storing of data from the memory area in response to a second value of the state-save control code.

14. The system of claim 11, wherein the allocation data further includes a control code, the second OS being further configured to:
release the memory area after the storing of data from the memory area in response to a first value of the control code; and
omit releasing of the memory area in response to a second value of the control code.

15. The system of claim 11, wherein the allocation data further includes a control code, and the storing of data from the memory area while booting the second OS is in response to a first value of the control code, the second OS being further configured to:
release the memory area after the storing of data from the memory area in response to the first value of the control code;
store the data from the memory area and omit the releasing of the memory area in response to a second value of the control code;
omit the storing of data from the memory area and release the memory area in response to a third value of the control code; and
omit the storing of data from the memory area and omit the releasing of the memory area in response to a fourth value of the control code.

16. The system of claim 11, wherein the interface is further configured to:
store allocation data describing each acquire request in a respective entry in an allocation list in response to each memory acquire request from the second OS to the interface; and
reading allocation data from the entries in the allocation list.

17. The system of claim 16, wherein the allocation data further includes a control code, and each entry in the allocation list has a respective control code value, the second OS being further configured to condition the storing of data from the memory area in response to the value of the respective control code value.

18. The system of claim 7, the second OS being further configured to condition release of the memory area referenced by an entry in response to the value of the respective control code value.

19. The system of claim 11, wherein the allocation data further includes a respective control code value for each memory acquire request, the second OS being further configured to condition storing of data from a respective memory area as referenced by the allocation data in response to the value of the respective control code.

20. The system of claim 19, the second OS being further configured to condition release of the memory area referenced by an entry in response to the value of the respective control code value.

21. An apparatus for recovering state data between boot sessions of an operating system, comprising:
means for executing a first operating system (OS), wherein the first OS includes instructions of a first instruction set that are native to an instruction processor;
means for emulating a second OS, wherein the second OS includes instructions of a second instruction set that are not native to the instruction processor;
means for interfacing the second OS to the first OS during emulation, wherein the means for interfacing, responsive to each memory acquire request from the second OS, returns a memory area for use by the second OS and stores allocation data associated with the memory area, including an address referencing the memory area and a boot sequence number, wherein the boot sequence number indicates a boot session of the second OS;
wherein while booting the second OS to a current boot session during emulation, the second OS retrieves the stored allocation data from the interface, and responsive to the stored allocation data including a selected boot sequence number, stores data from the memory area referenced by the address in the allocation data in retentive storage.
